(19) United States
(12) Patent Application Publication
(10) Pub. No.: US 2010/0332525 A1
(43) Pub. Date: Dec. 30, 2010

(54) PARAMETERIZATION OF KEYWORDS FOR AUTOMATED ENTRIES

(76) Inventors: Tyler Gildred, Santa Ynez, CA (US); Travis Purdy, Shell Beach, CA (US)

Correspondence Address: Cislo & Thomas LLP, 1333 2nd Street, Suite #500, Santa Monica, CA, 90401-4110, US

(21) Appl. No.: 12/830,269

(22) Filed: Jul. 2, 2010

Related U.S. Application Data
(63) Continuation-in-part of application No. 12/253,503, filed on Oct. 17, 2008.
(60) Provisional application No. 61/222,882, filed on Jul. 2, 2009.
(60) Provisional application No. 60/981,416, filed on Oct. 19, 2007.

(51) Int. Cl. G06F 15/16; G06F 17/30

(52) U.S. Cl. 707/769; 709/203; 707/E17.014

(57) ABSTRACT

A server-side parameterization of a client-generated free-form string for reducing the number of server calls, the keywords within the string detailing information about an item evaluated by the server to produce recommendation data and automatically generated data about the item to the client. The client device receives input from a user. In turn, the client device generates a free-form string from the input. The server receives the free-form string of keywords. The server processes the free-form string and returns a parameterization of the keywords within the free-form string back to the client device. The parameterization of the string by the server can include matching condition keywords, matching manufacturer keywords, matching model keywords, applying category recommendations, applying user-specific recommendations, applying server-specific recommendations, applying attribute recommendations, auto-generating titles, and auto-generating descriptions. The parameterization of the keywords provides information on how to list the item on the online marketplace or advertising website.

### CROSS-REFERENCES TO RELATED APPLICATIONS

This patent application claims the benefit of U.S. Provisional Patent Application Ser. No. 61/222,842, filed Jul. 2, 2009, and is a continuation-in-part of U.S. patent application Ser. No. 12/253,503, filed Oct. 17, 2008, which claims the benefit of U.S. Provisional Application Ser. No. 60/681,416, filed Oct. 19, 2007, all of which are hereby incorporated in their entirety by this reference, including any appendices, screen shots, and references therein.

### TECHNICAL FIELD

This provisional application generally relates to online marketplaces or advertising websites, and, more particularly, to a server-side parameterization of a client-generated free-form string for reducing the number of server calls, the keywords within the string detailing information about an item evaluated by the server to produce recommendation data and automatically generated data about the item to the client.

### BACKGROUND

As disclosed in U.S. patent application Ser. No. 12/253,503 titled SYSTEM AND METHOD FOR AUTOMATED ENTRY INTO-ONLINE AUCTION OR SALE SERVICES EMPLOYING A WIRELESS DEVICE, camera/smart phones were used for selling and buying products and services associated with an online marketplace or advertising website. In normal operations, however, the camera/smart phones often drop calls due to a variety of factors. For example, when a mobile phone moves out of range of a wireless network, the call is terminated when a signal can no longer be maintained between the phone and the network. In other cases of lost communication, the wireless communication in which the mobile phone operates becomes unavailable, interfered with, or jammed.

In typical applications that run atop camera/smart phones, constant communication over a network with a server is required. Multiple calls to the server and responses therefrom can take valuable processing time and bog down the camera/smart device to a stand still as well as the server. Thus, there remains a need for better technology for reducing the number of server calls. The present application addresses this need and other shortcomings in the prior art.

### SUMMARY

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter.

In accordance with one aspect of the present application, a system is presented. The system includes a client device for receiving input from a user. The client device generates a free-form string from the input. The input has keywords describing properties of an item to be posted on an online marketplace or advertising website. In addition, the system includes a server for receiving the free-form string of keywords. The server processes the free-form string and returns a parameterization of the keywords within the free-form string. The parameterization of the keywords provides information on how to list the item on the online marketplace or advertising website.

In accordance with another aspect of the present application, a server for providing a client with a plurality of recommendations about an item is presented. The server includes at least one processor. In addition, the server includes a database for storing condition keywords, list of manufacturers, and model keywords. Furthermore, the server includes a memory operatively coupled to the processor. The memory stores program instructions, that when executed by the processor, causes the processor to perform a series of routines.

These routines can include receiving keywords from a user and performing a series of actions designed to parse the keywords into an array. Furthermore, the routines include matching conditions to the keywords within the array to the condition keywords stored in the database. In addition, the routines include matching manufacturers to the keywords within the array to the manufacturers in the list of manufacturers stored in the database. The routines include matching models to the keywords within the array to the models in the model keywords stored in the database and providing recommendations to the user based on the matched conditions, manufacturers, and models.

In accordance with still yet another aspect of the present application, a computer-implemented method for identifying an item is presented. The method includes receiving keywords about the item, the keywords in the form of a string. Furthermore, the method includes sending a request along with the string to a server, the server processing the string and generating a parameterization of the keywords within the string, the parameterization including recommendations based on matched conditions, manufacturers, and models. In addition, the method includes receiving the recommendations from the server and determining if any changes are made to the recommendations and if changes have been made, sending those changes to the server.

### BRIEF DESCRIPTION OF ATTACHMENTS

ATTACHMENT A (6 Pages) titled “The Zuujit Process” discloses client-server interactions when listing a new item. In particular, the disclosure represents those interactions that take place on eBay. ATTACHMENT A is hereby incorporated by reference in its entirety, including, any appendices, screen shots, and references thereto.

### BRIEF DESCRIPTION OF DRAWINGS

The novel features believed to be characteristic of the application are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The application itself, however, as well as a preferred mode of use, further objectives and advantages thereof, will be best understood by reference to the following detailed description of illustrative embodiments when read in conjunction with the accompanying drawings, wherein:

FIG. 1A is a block diagram showing an exemplary architecture depicting elements contained within an illustrative remote wireless device in accordance with one aspect of the present application;

FIG. 1B is a block diagram showing an exemplary architecture for interaction between the remote wireless device, the service system and the sales listing system in accordance with one aspect of the invention;

FIG. 2A is a block diagram depicting an illustrative registration process in accordance with one aspect of the present application;

FIG. 2B is a block diagram depicting an illustrative account creation and selection process in accordance with one aspect of the present application;

FIG. 3A is a block diagram depicting an illustrative listing process in accordance with one aspect of a first embodiment of the present application;

FIG. 3B is a block diagram depicting an illustrative service system server companion processes for listing items in accordance with one aspect of a first embodiment of the present application;

FIGS. 3C, 3D and 3E are block diagrams depicting an illustrative listing process in accordance with a second embodiment of the present application with interactive service system server companion processes;

FIG. 4 is a block diagram illustrating an exemplary post sale process in accordance with one aspect of the present application;

FIGS. 5A through 5I are exemplary implementations of the illustrative system on a PDA or cell phone for the listing process including data entry and imaging in accordance with one aspect of the present application;

FIGS. 6A through 6C are exemplary implementations of the illustrative system on a PDA or cell phone for account maintenance and review in accordance with one aspect of the present application;

FIGS. 7A and 7B are exemplary implementations of the illustrative system of the PDA or cell phone for post sale shipment and other general functions in accordance with one aspect of the present application;

FIG. 8 is a block diagram representing a typical client device to interact with other devices or networks associated with the client device in accordance with one aspect of the present application;

FIG. 9 depicts a block diagram showing communications between an exemplary customer machine interacting with a server that provides parameterized data back to the client device in accordance with one aspect of the present application;

FIG. 10 provides an illustrative flow chart for parsing a string of keywords received from a client device in accordance with one aspect of the present application;

FIG. 11 is an exemplary flow chart for matching keywords provided by the client with item conditions in accordance with one aspect of the present application;

FIG. 12 diagrams a flow chart for matching keywords provided by the client with manufacturers in accordance with one aspect of the present application;

FIG. 13 shows a flow chart for matching keywords provided by the client with models in accordance with one aspect of the present application;

FIG. 14 is a block diagram that provides illustrative recommendations based on the received keywords and matches made in accordance with one aspect of the present application; and

FIG. 15 is a block diagram that provides illustrative generations based on the received keywords and matches made in accordance with one aspect of the present application.

### DESCRIPTION OF THE APPLICATION

The description set forth below in connection with the appended drawings is intended as a description of presently-preferred embodiments of the application and is not intended to represent the only forms in which the present application can be constructed and/or utilized. The description sets forth the functions and the sequence of steps for constructing and operating the application in connection with the illustrated embodiments. It is to be understood, however, that the same or equivalent functions and sequences can be accomplished by different embodiments that are also intended to be encompassed within the spirit and scope of this application.

System Overview

Generally described, this provisional application relates to online marketplaces or advertising websites, and, more particularly, to a server-side parameterization of a client-generated free-form string for reducing the number of server calls, the keywords within the string detailing information about an item evaluated by the server to produce recommendation data and automatically generated data about the item to the client. In one illustrative embodiment, a system having both a client device and a server is provided. The client device receives input from a user. The client device can be, but is not limited to, a “Palmtop”, Smartphone, iPhone, Blackberry, handheld, or Personal digital Assistant (PDA). In turn, the client device generates a free-form string from the input. The input includes keywords that describe properties of an item to be posted to an online marketplace or advertising website.

Continuing with the illustrative embodiment and in addition to the client device described above, the system includes a server for receiving the free-form string of keywords. The server processes the free-form string and returns a parameterization of the keywords within the free-form string back to the client device, the parameterization including recommendation data. The parameterization of the string by the server can include, but is not limited to, matching condition keywords, matching manufacturer keywords, matching model keywords, applying category recommendations, applying user-specific recommendations, applying server-specific recommendations, applying attribute recommendations, auto-generating titles, and auto-generating descriptions. The parameterization of the keywords provides information on how to list the item on the online marketplace or advertising website, i.e. recommendation data, and is returned to the client device.

In essence, parameterization of the keywords within the free-form string by the server reduces the number of calls and responses made between the client device and the server. Reducing the number of calls and responses can lessen dropped calls within networks. Furthermore, processing times on the mobile devices is lowered as the only requirement is generating a free-form string, which the server can process.

While this provisional application discusses parameterization of keywords with respect to a listing or selling an item on an online marketplace or advertising website, one skilled in the relevant art will appreciate that the system and methods described herein can be applied to other areas of communication between a client device that interacts with a server or third-party server. For example, communications between an application on top of a client device and a realtor's website.

Continuation-in-Part

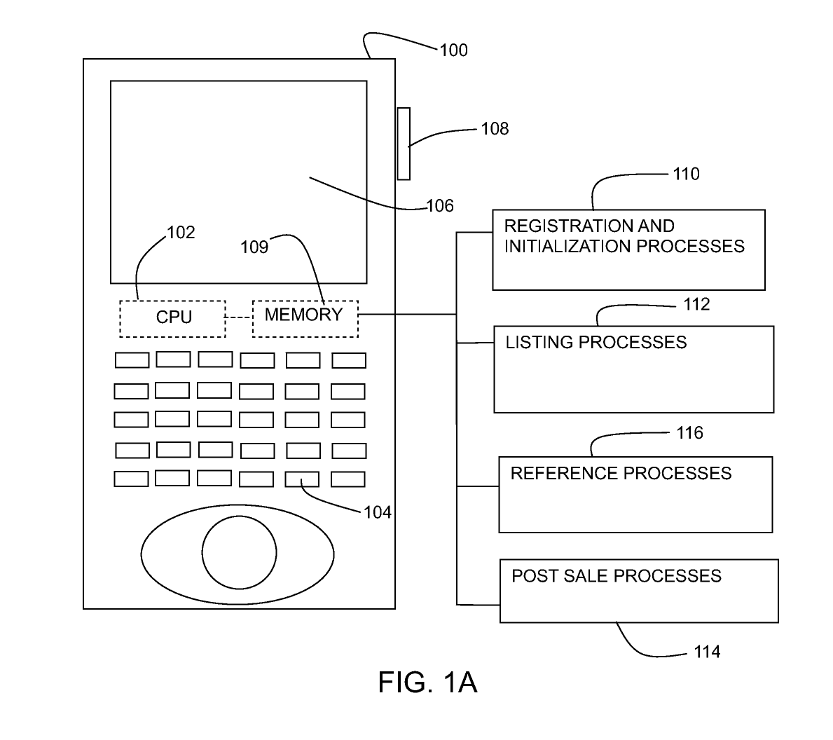

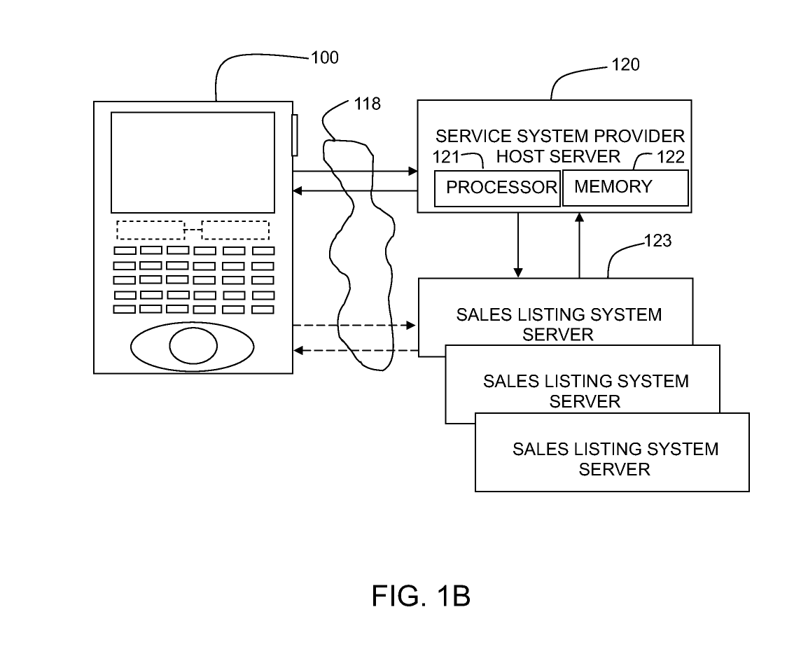

For the purpose of clarity, the non-provisional application to which this provisional application claims priority is hereinafter substantially repeated. The previous application incorporated a wireless device as shown in FIG. 1A such as a cellular phone or PDA 100 having an integral central processing unit (CPU) 102, an input keyboard 104, display 106 and an integrated camera 108. An operating memory 109 interacts with the CPU and incorporates multiple processing modules including a Registration and Installation Process 110 for installing components of the system on the PDA 100, a Listing Process 112 for employing the PDA within the installed system and integrated camera for entering the sales details of an item and communication with the selling agency for transmission/verification of the sales details and a Post Sale Process 114 for transaction notification and completion. Embodiments of the application as implemented include additional functions for preference settings and reference processes 116 associated with the PDA operation for listing development and communication with the selling agency.

As shown in FIG. 1B, the PDA communicates over a network 118 with a provider host server 120 for a service system that provides downloads of the various modules to the PDA. The server incorporates processor 121 and a memory 122 or other storage capability. In certain embodiments, the provider host servers interface with servers 123 of a sales listing system for actual communication of listings. In alternative embodiments, the PDA communicates directly with the sales listing system servers for actual listing of the item for sale.

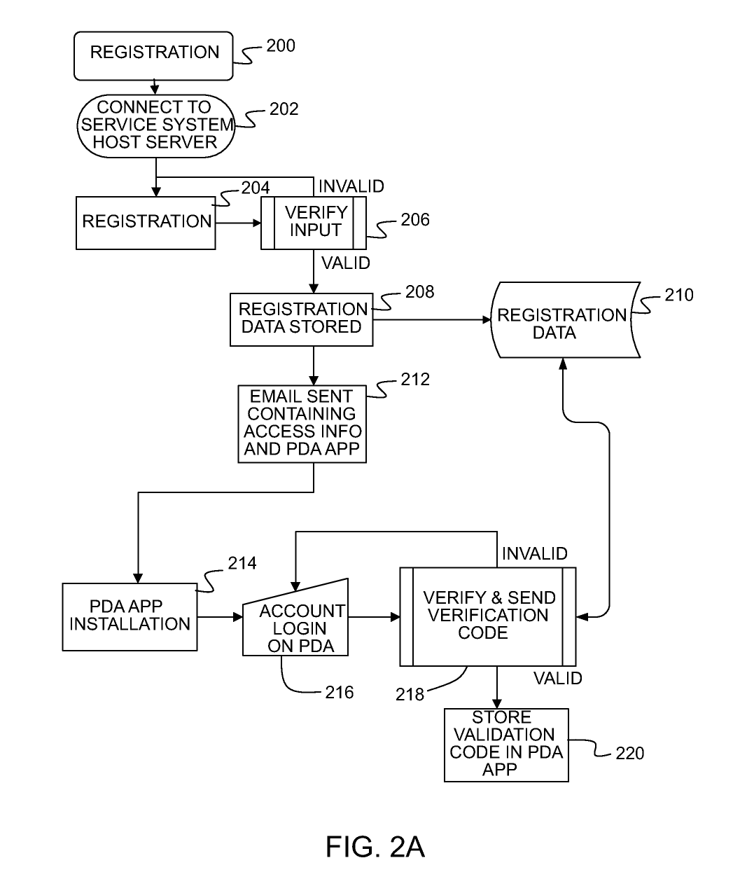

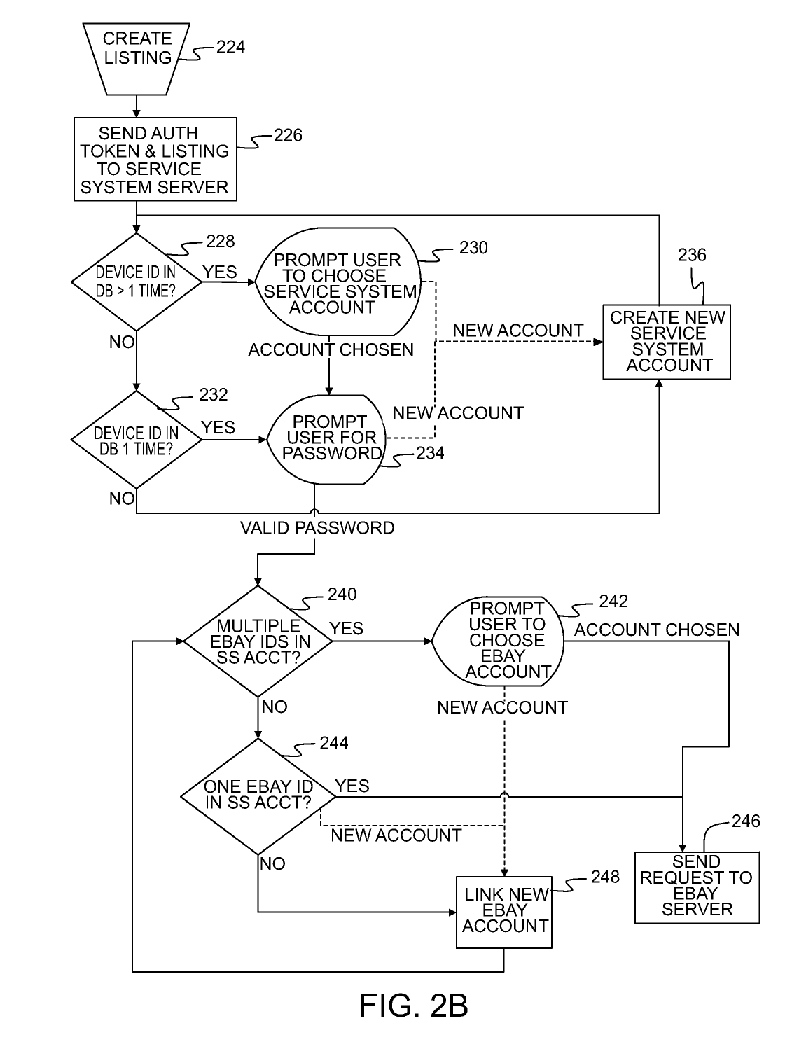

Referring to FIG. 2A, the Registration and Installation Process 110 includes downloading of interactive modules to the PDA 100 through a wireless web connection from a service system provider, entry of registration data for the user via the web connection to the service system servers and an activation process for installation of the interactive modules. The registration process begins at block 200. At block 202, a PDA 100, equipped for incorporating the modules described above, is wirelessly connected to a host server for the service system, and registration information is transmitted to the server at block 204 with the server verifying the input at block 206. If invalid input is received, an appropriate message is returned to the PDA and the system returns to block 204 for transmission of registration information. A valid input results in storage of the PDA data at block 208 in a database 210 associated with the service system. An e-mail or similar type of communication is sent by the service system server at block 212 providing access information and the downloadable application software for the system modules. The downloaded application is installed on the PDA at block 214 and the PDA is then enabled for account login at block 216. Upon logging-in to the host, the host will verify the PDA data and application modules and if valid, will provide a validation code at block 218 to be stored in the PDA for future use at block 220. The registration and installation process is then complete. If an invalid input is received upon account login, the host will respond with an error message and return to block 222 for account login.

In addition to initial registration and downloading of the software system to the PDA, FIG. 2B demonstrates an exemplary process for registration of accounts in the system. Upon entering the system to create a listing at block 224, the PDA sends an authorization token and listing request to the server at block 226. The server determines if a device ID exists in the service system database (DB) at more than one location at decision block 228. If so, the user is prompted on the PDA display to choose the appropriate account relating to that device ID at block 230. If the device ID only exists once in the service system database at decision block 232 or upon selection of the desired account, the user is prompted on the PDA display to enter a password at block 234. If the device ID does not exist in the service system database, a new account is created at block 236 as previously described in blocks 218 through 222 of FIG. 2A. Upon entry of a valid password by the user, a determination is made if multiple account IDs for the selected listing service, such as eBay, Amazon, or Craigslist are present at decision block 240. If so, the system directs the PDA to display a prompt for the user to choose one of the accounts at block 242. If multiple account IDs do not exist for the listing service, a determination is made if one ID exists at decision block 244. If one ID exists or upon choice of the desired account by the user responsive to the prompt at block 242, the service system forwards the listing request to the listing server at block 246 (an E-bay server in the drawing example). If no listing service ID is present, a link is created to the listing service for creation of a new account at block 248. At the prompt for either block 242 or block 244 the user has an option of creating a new account.

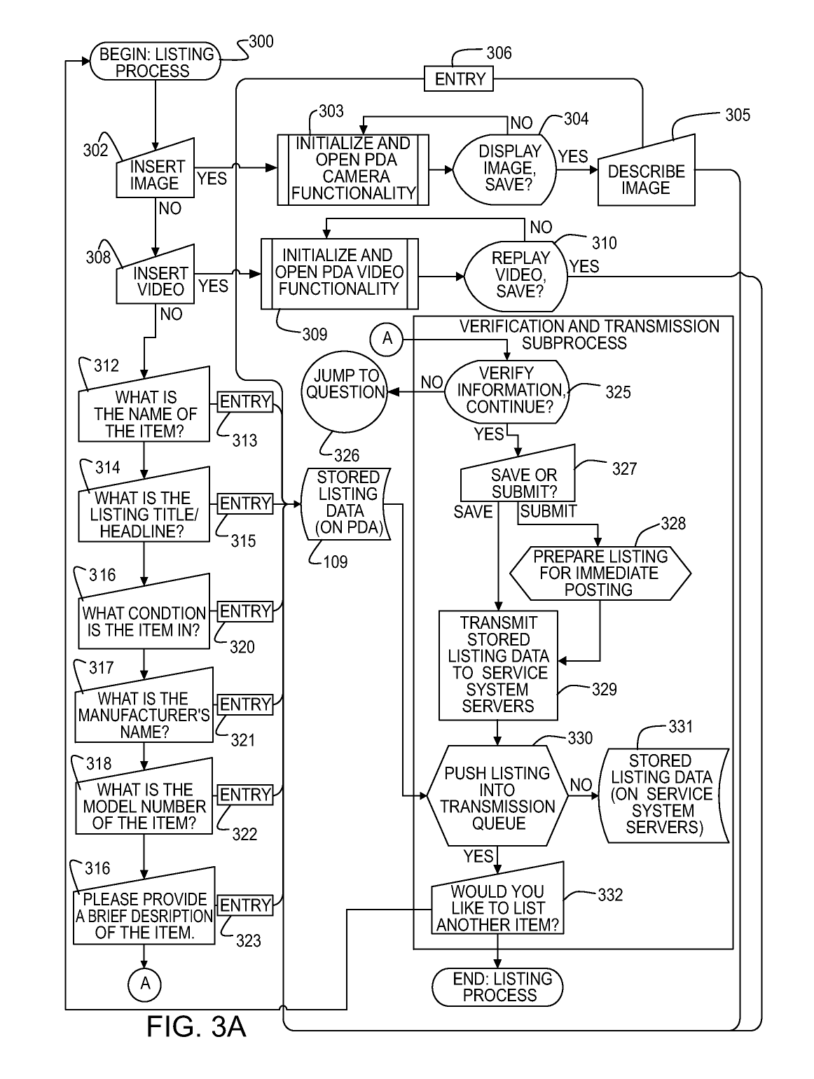

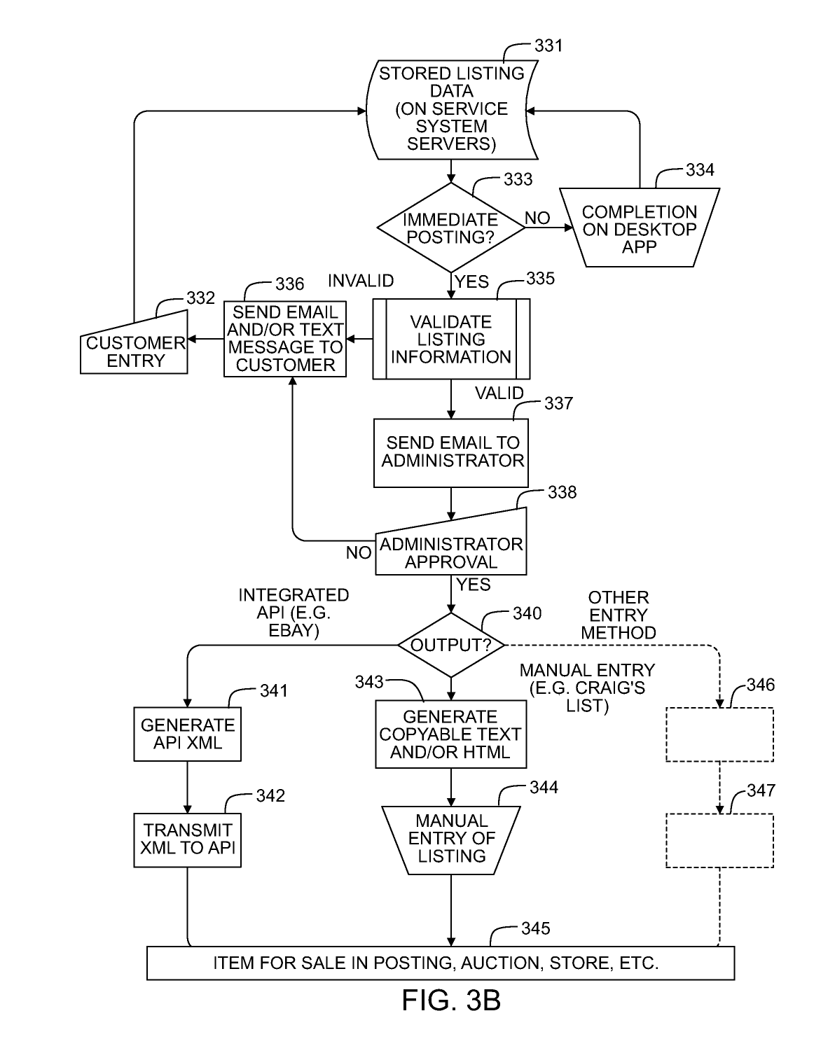

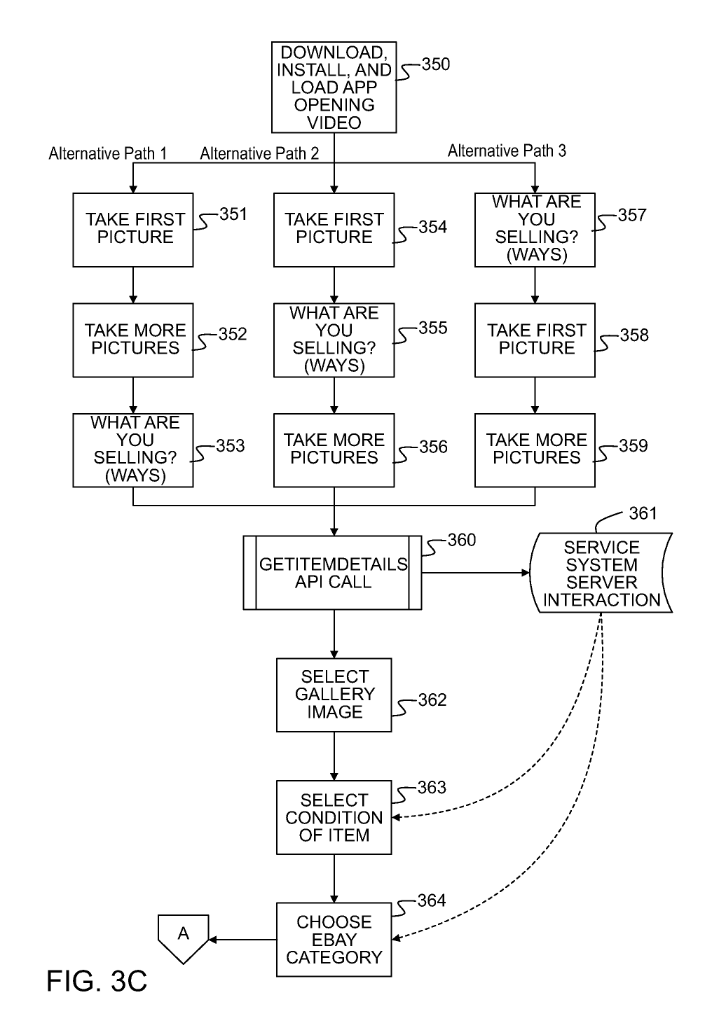

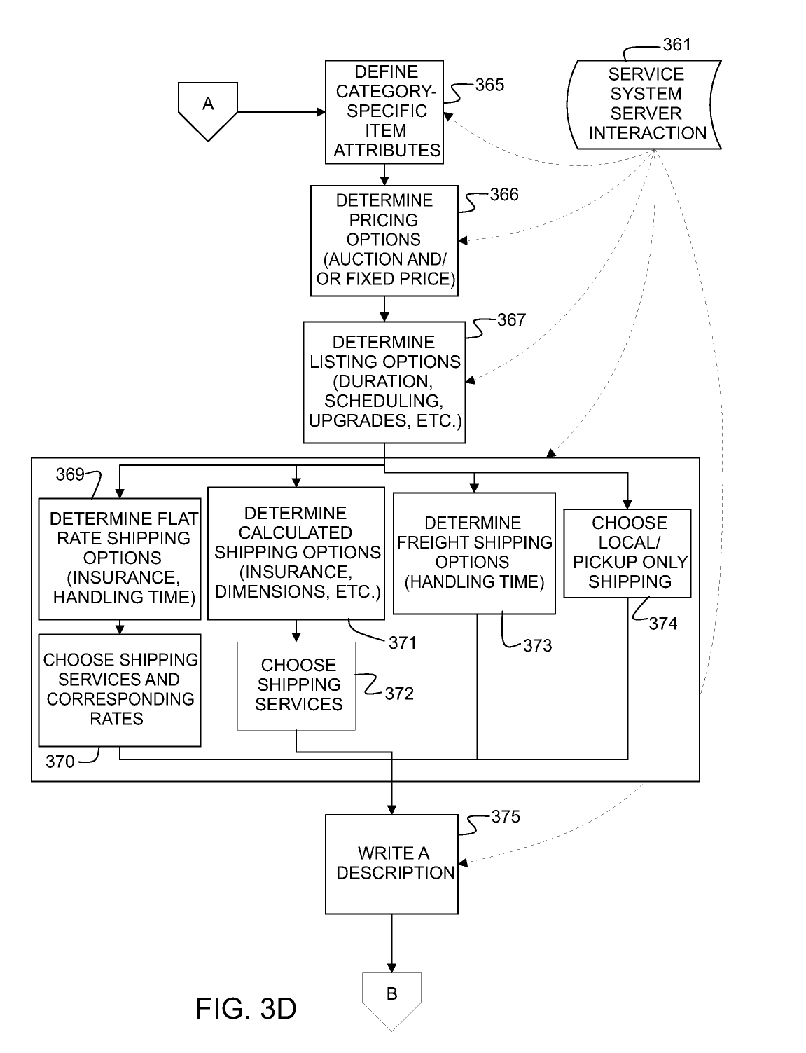

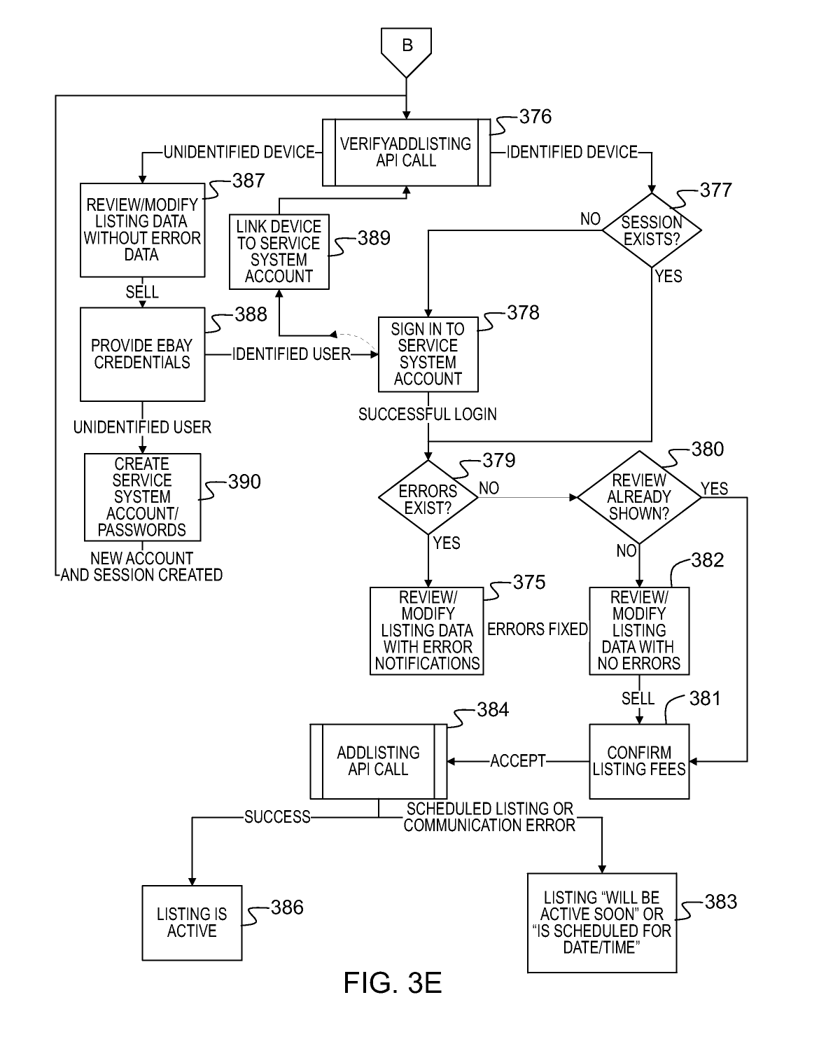

The Listing Process for a first embodiment, shown in detail in FIG. 3A, includes a plurality of routines prompted by the interactive modules on the PDA which can be accomplished prior to entry into the service system server for listing of a sale item to save time and minimize wireless connection time issues. Commencement of the listing process 300 on the PDA is prompted by a request for photo entry at block 302. Using an integrated camera in the PDA or cell phone, the PDA initializes and opens the camera functionality at block 303. The image taken by the user is displayed and a prompt to save the image is provided at block 304. If the image is not sufficient or accepted by the user, the user can select not to save the image and the PDA reverts to the camera mode. If the user saves the image, a prompt is provided for a description of the image at block 305 which is then entered at block 306 on the PDA keypad and a return to the prompt for images is made. Each entry such as block 306 and those subsequently defined are stored on the PDA as listing data as will be described in detail below.

A prompt for video input is then made at block 308 and if selected, the PDA initializes and opens the PDA video functionality at block 309. Upon completion of video input, a prompt for viewing and saving the video is provided at block 310. If not saved, the system reverts to the video input prompt. If saved by entry 311, the data input for the item is stored in the PDA. Multiple items can be prepared for listing and stored on the PDA.

The system then prompts the user for an item name at block 312 which is entered at block 313 using the PDA keypad. A listing title or headline (which can be prompted in a specific format for predetermined sales service providers (i.e. E-bay)) is requested at block 314 and entered at block 315. The item condition at block 316, manufacturer at block 317, model number at block 318 and item description at block 319 are requested with PDA inputs by the user reflected at blocks 320, 321, 322 and 323. Each entry stores data in the memory 109 of the PDA.

A verification and transmission process module at block 324 is activated when the user elects to transmit data to the sales service provider which allows a data review and communicates with the provider (including selection of provider in certain embodiments). A verification routine at block 325 allows the user to scroll through the information input in the listing process and, if a data change is required, allows jumping at branch 326 to the entry question (blocks 312, 314, 316, 317, 318 and 319) for correction/entry. The user is then prompted to save the listing data to the host at the service provider or submit the listing at block 327. The data save to the host allows further processing by the user from a companion desktop application at a personal computer or other network device if more convenient. If a “submit listing” choice is made, the system prepares the listing for immediate posting at block 328. After the listing preparation or if storage on the service system server has been selected, a transmission module at block 329 is activated. The PDA accomplishes a log-in as previously described with respect to FIG. 2B and the PDA pushes the listing into a transmission queue at block 330 retrieving data from the PDA memory which has received each of the listing inputs. The data for the item is then stored on the service provider host server at block 331.

Companion modules on the service system server receive the item data, perform listing functions and actual listing of the item, and confirm communications to the PDA of the listing and sale monitoring/notification functions. As shown in FIG. 3B, the data stored from the PDA is available on the host server data storage at block 331. If the host determines that immediate posting was not selected by the user at block 333, the host module makes the data available for interaction with a PC or other network terminal available to the user for completion of the listing at block 334. If posting has been directed, the host validates the listing information at block 335, and if invalid, generates an e-mail and/or text message to the user at block 336, which is received by the PDA. User input from the PDA through the verification routine previously described provides revised data in the stored data listing for processing. A valid listing results in an e-mail or similar type of communication to the service system server administrator at block 337 for approval of the posting at block 338. If posting is not approved, the service system server reverts to block 336 sending an e-mail or similar type of notification to the user. If the posting is approved, an output will be made at block 340, and a service provider host with an integrated API will generate an appropriate XML for the API at block 341 and transmit the XML to the API for operation at block 342. Alternatively, the service provider administrator will generate copyable text and/or HTML at block 343 and provide manual entry of the listing at block 344. The item posted will then be shown in the service providers, posting, auction or store at block 345. Alternative listing service data entry protocols represented generically as blocks 346 and 347 can be accommodated.

An alternative embodiment for the listing process is shown in FIGS. 3C through 3E. The process of software download, installation and initiation at block 350 is accomplished as previously described. Upon opening the listing application on the. PDA three optional paths are available to the user. In the first alternative path, a prompt is provided on the screen requesting the user to take a first picture. Upon entry of the image at block 351, a prompt is provided on the screen for additional pictures. If the user takes additional pictures, images are entered at block 352, and a prompt is provided on the screen for “what are you selling” (WAYS) with entry of an item title by the user at block 353. In the second alternative path entry of a first image, block 354 results in a prompt for WAYS with entry of an item title by the user, block 355. A prompt is then provided on the screen for additional pictures and additional images are entered at block 356. In the third alternative, the WAYS is prompted on the screen and entered by the user at block 357. A prompt for a first picture is then provided with entry of the image taken by the user at block 358. A prompt for additional pictures is provided on the screen and, if the user takes additional pictures, images are entered at block 359.

The PDA then establishes wireless contact with the service system provider host at block 360 to commence the listing interaction. The service system provides interactive analysis and processing of the various listing input parameters to provide automated assistance where applicable at block 361. A gallery of the images entered for the listing is then presented to the user and a selection of the desired image is made at block 362. A prompt is then provided to select the condition of the item and a condition entered or selected by the user is stored at block 363. A prompt is then provided to select a category for the listed item consistent with the listing service to be used and the chosen category is entered at block 364.

A prompt is then made to define category specific item attributes which are then entered as defined by the user at block 365. Based on the listing service to be used, a determination of pricing options, such as auction or fixed-price, is made at block 366, and listing options such as the duration of the auction, scheduling time for the auction and other listing service features are determined at block 367. For listing services where multiple shipping options are provided, screen prompts and data entry are accomplished, generally designated at block 368. For an exemplary listing service, a determination is made regarding flat rate shipping options such as insurance and handling time at block 369 and the shipping services and corresponding rates are then chosen at block 370. As a first alternative calculated shipping options are determined at block 371, and the appropriate shipping service is chosen at block 372. As a second alternative a determination is made regarding freight shipping options at block 373, and in the fourth alternative local pickup is selected at block 374.

A description is then written for the listed item at block 375, which incorporates the information entered in the interactive listing process on the PDA as set forth above. The description can be a compilation of the entries as entered or can be tailored by interactive operation with the service system's server. A review of the description by the user interactive alteration of the various inputs or recommendations can then be accomplished.

As a continuation of the listing process, or as a subsequent wireless contact, the PDA calls the service system provider host for verification of the ad listing at block 376. If upon the call the provider host recognizes the PDA as an identified device, a determination is made if a wireless session exists at block 377. If a session does not exist signing in to the service system account at block 378 is accomplished as previously described. Upon a successful log in or if a prior session did exist, a determination is made if errors in the listing are present at block 379. A determination is then made if a review of the listing by the user has been made on the PDA at block 380. If the listing has been reviewed by the user, a confirmation of listing fees to be charged by the sales listing service is made at block 381.

If the user has not yet reviewed the listing, data for the review is provided on the PDA screen at block 382, and if no errors are identified or changes made by the user as designated by a “sell” instruction, the listing fees are then confirmed. Similarly, if errors do exist in the listing as detected by the provider host, listing data for a review with error notifications is presented to the user at block 383. Entries by the user to fix the identified errors results in presentation of the listing data as previously defined for block 382.

Upon acceptance of the listing fees the provider host issues a listing call to the listing service server at block 384. A successful interaction between the provider host server and the listing service server results in an active listing at block 385. If the listing is subsequently to be scheduled or a communications error occurs between the service provider host and listing service server, notification is provided to the user on the PDA screen at block 386.

If the device is unidentified during the verify add listing call of block 376, a data review for the listing is presented at block 387, and upon a sell command from the user listing, service credentials are provided at block 388. An identified user is then signed into the service system account as previously defined in block 376 and the device is linked to the service system account at block 389. If the user remains unidentified, a service system account is created at block 390, and the new account and session are created.

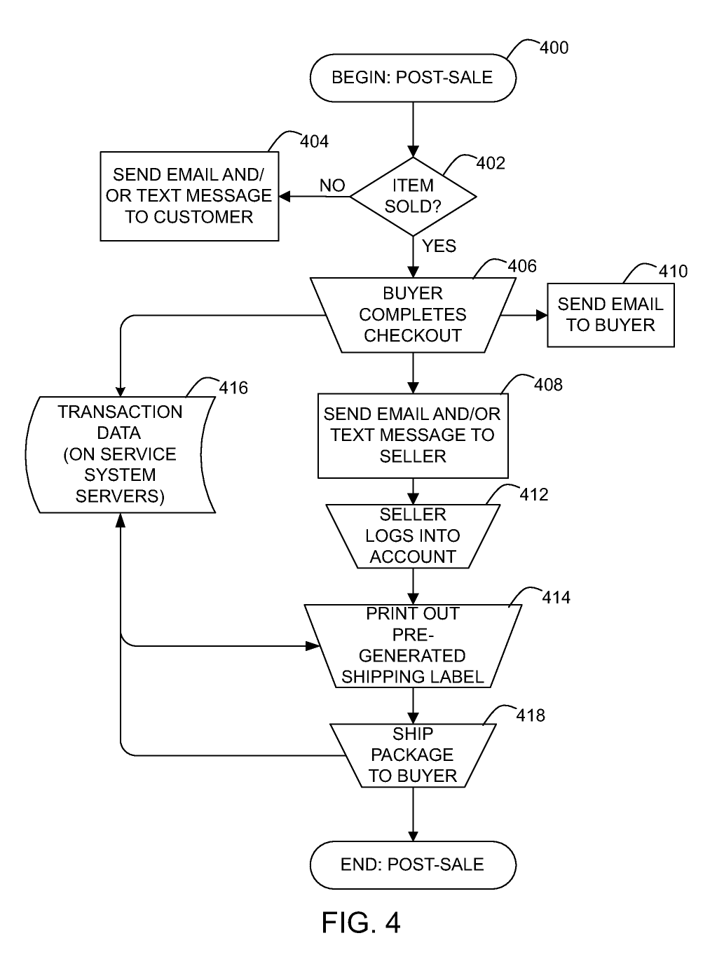

The Post Sale Process 400 shown in FIG. 4 employs the companion modules at the service provider host to monitor the posting for sale at block 402. If the item is not sold, the host sends a text message or email notification to the PDA notifying the user at block 404. If the item is sold, and the buyer completes the internal checkout processes of the provider at block 406, the host sends a text message or email notification to the PDA of the sale at block 408. Standard host processing for notification of the buyer through e-mail is also accomplished at block 410 and the transaction data for delivery is stored at the host at block 412. Upon receipt of the “sale” message, the PDA system then provides automated interactive modules to the user to log into the account at block 412 for shipping instructions and printing out a pre-generated shipping label at block 414 through interaction with the transaction data at block 416 saved on the host data storage system. Upon shipment of the package to the buyer, the PDA system is used to transmit a shipment notice at block 418 to the host for storage on the host data system and post sale requirements.

A system employing the previous application is compatible with advanced PDAs and cellular phones which preferably provide, as described previously with respect to FIG. 1A, a touch sensitive screen 106 and standard cursor controls 107 for manipulating data on the screen. A keypad 104 for data entry provides input for the various text elements required by the system. In alternative embodiments, use of stylus written input using systems such as Palm® Graffiti or a keyboard image on the screen and with touch activation can be employed.

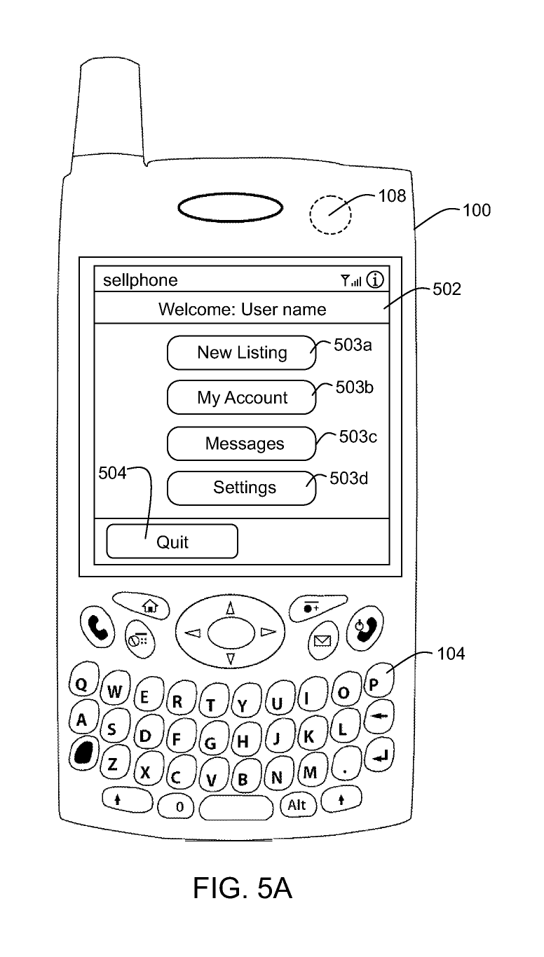

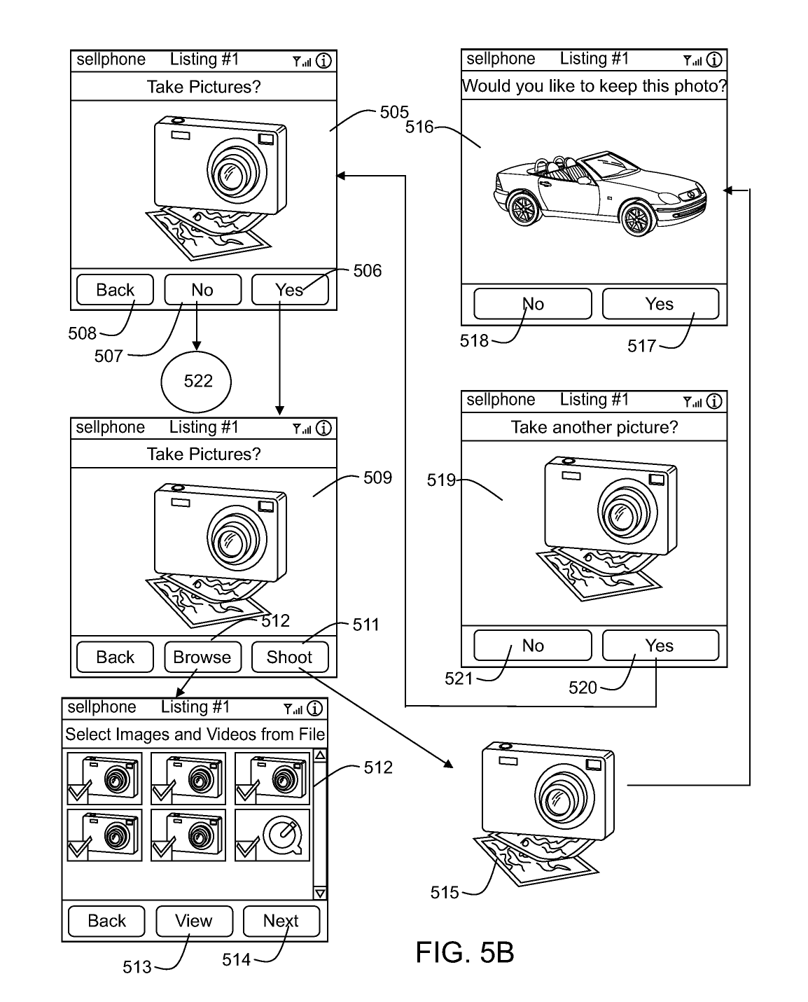

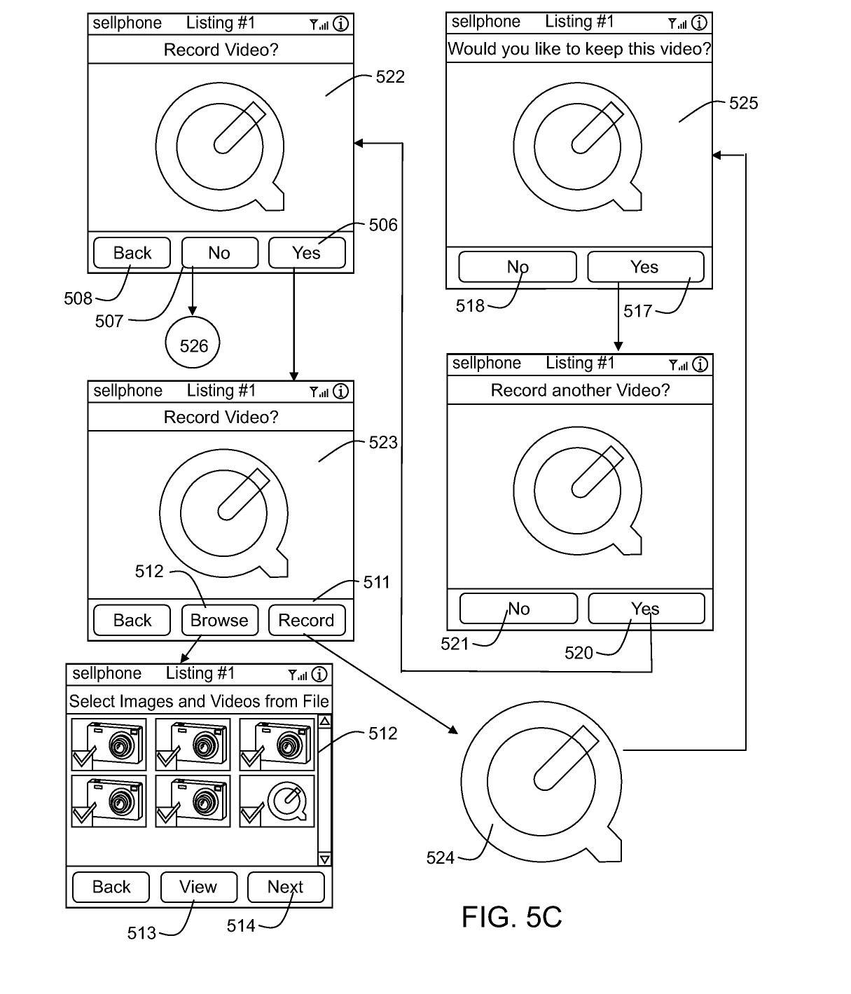

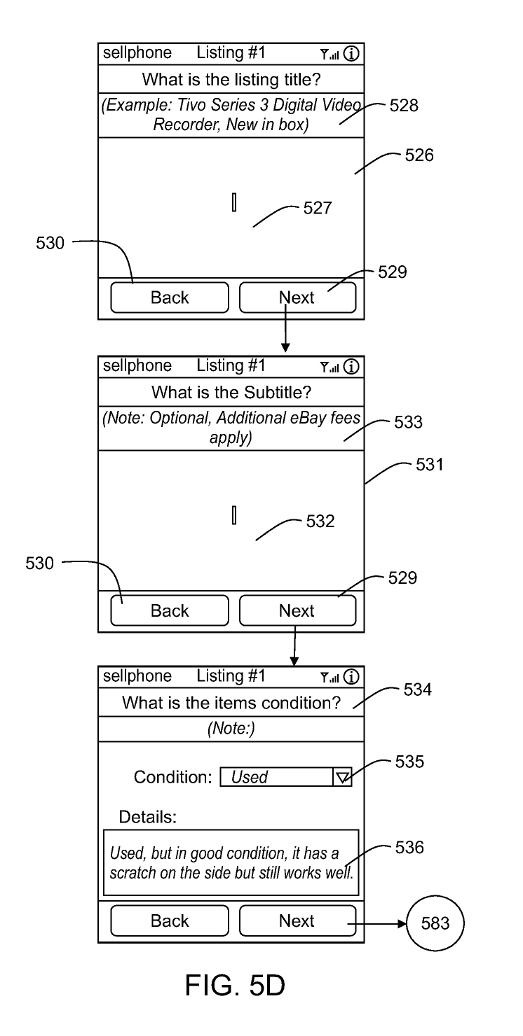

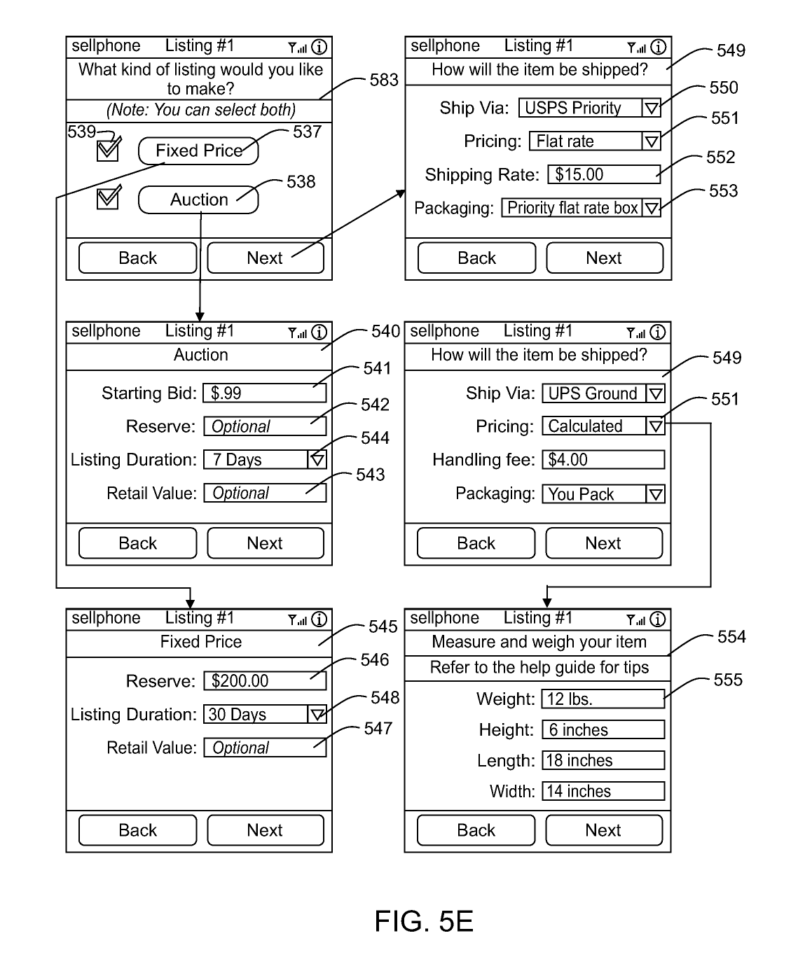

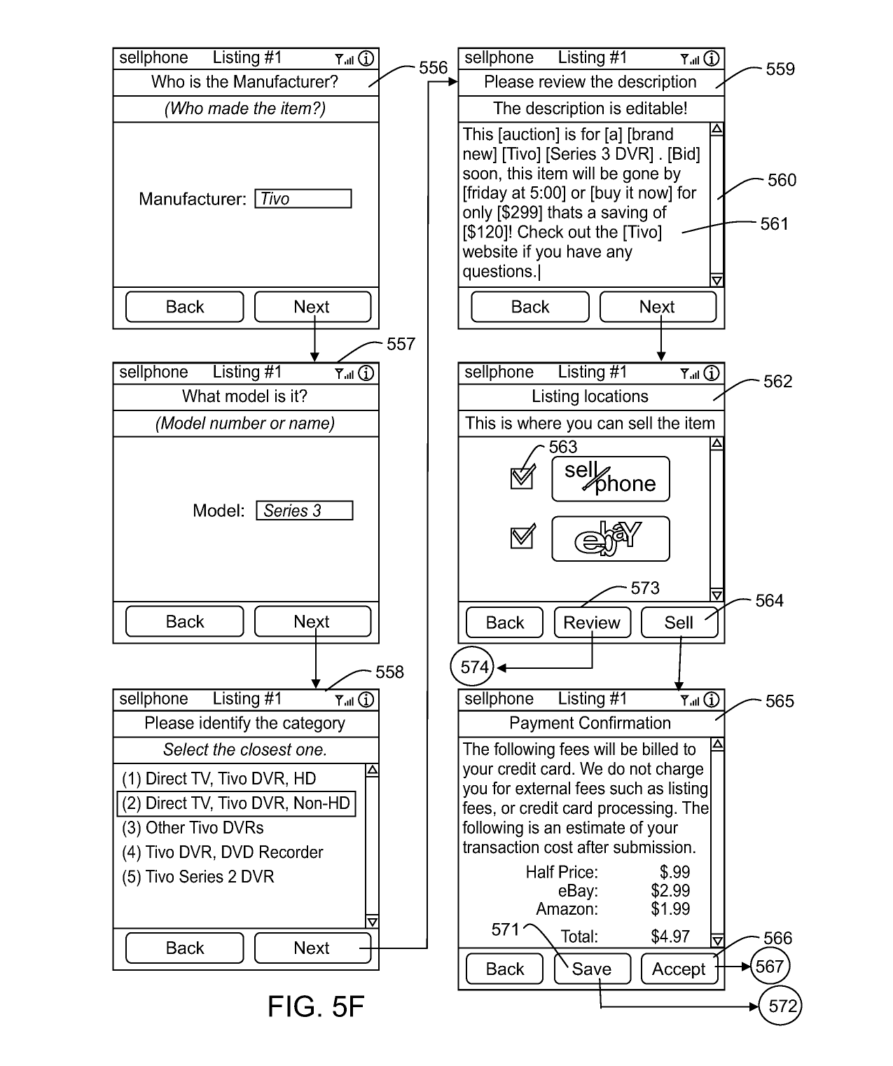

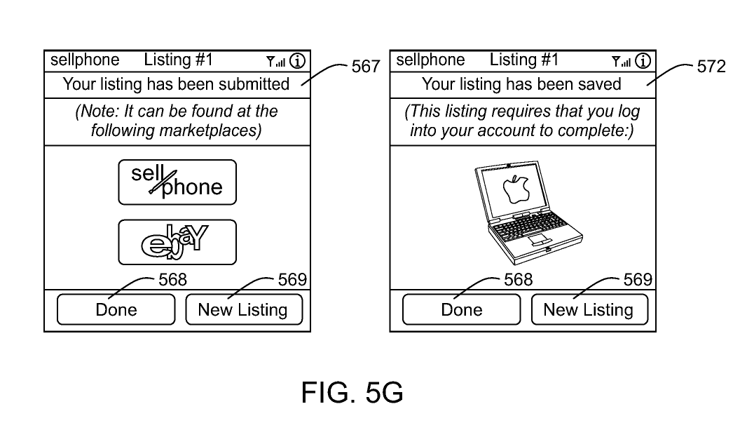

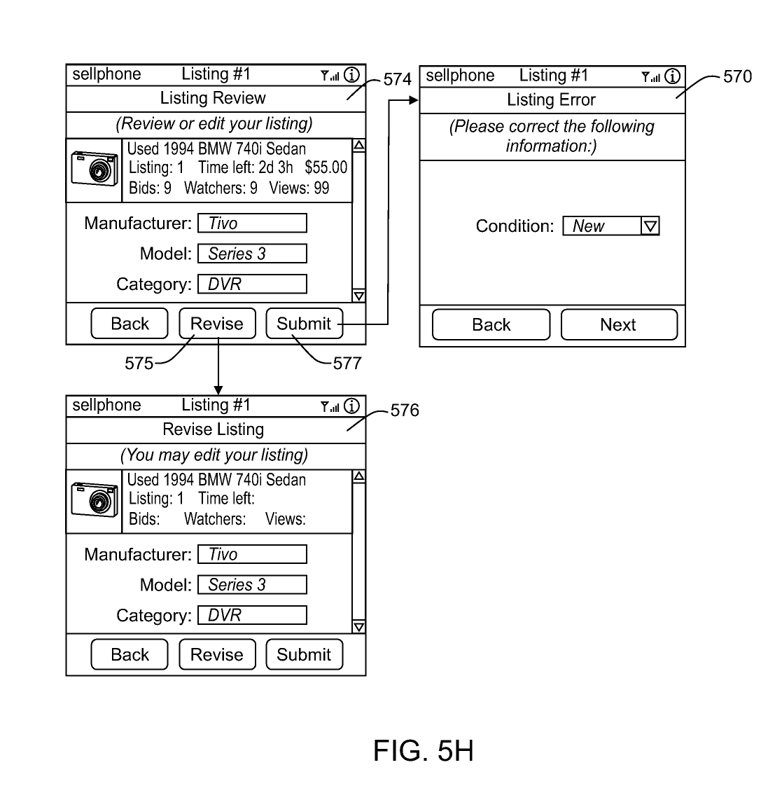

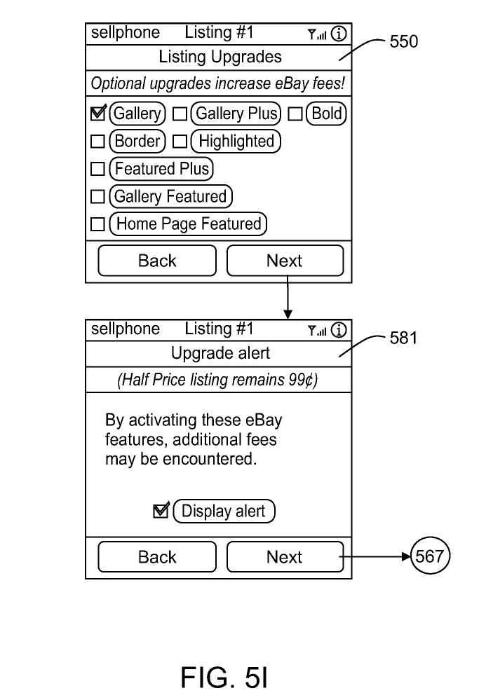

An exemplary embodiment of the inventive system, employed on an advanced PDA/Cellular Phone such as a Palm® Treo™ Smart Phone with touch screen capability activated by contact of the user's finger or a stylus (referred to herein as “touching”), is shown with interactive screen shots for the PDA using processes described in FIGS. 5A through 5I, 6A through 6C and 7A through 7D. Referring to FIGS. 5A through 5I, the system display for the exemplary embodiment provides a welcome screen 502 when initialized. The initial screen includes multiple interactive buttons for selection of available functions such as new listing 503a, my account 503b, messages 503c, and settings 503d. A quit button 504 allows for exiting the program. Touching the new listing button brings up a photo entry screen 505 as shown in FIG. 5B. The screen provides buttons for function selections: a yes button 506 to engage the camera function or a no button 507 to advance to the next screen. A back button 508 is provided to return to the listing text element screens. If the yes button is touched, a photo selection screen 509 is presented providing the option to select a photo from memory with a browse button 510 or capture a new image with a shoot button 511. Touching browse brings up an image memory screen 512 displaying icons for photos and video available in memory on the PDA. A view button 513 allows a selected image/video to be viewed and a next button 514 allows the image to be entered as the selected photo for the listing.

Alternatively, if a new photograph is desired, touching the shoot button on the photo entry screen initializes the internal camera function of the PDA allowing normal image capture represented by icon 515. The image is then displayed in a photo confirmation screen 516 which prompts the user to accept the image with a yes button 517 or reject it with a no button 518. A no selection deletes the image. A yes selection stores the image and brings up an additional photo selection screen 519 which provides a yes button 520 and a no button 521. A yes selection returns to the image capture sequence. A selection of the no button enters the image or images taken into the listing and advances to a record video option screen 522 providing a selection sequence for video comparable to the photo selection having video selection screen 523 with access to the image memory through screen 512 or activation of the internal video capture capability of the PDA 524, video confirmation 525 is provided having similar functionality to the image screen 516 as previously described. Upon completion of the image entry routines, a listing title screen 526 is presented which prompts the user to enter a title for the listing in a text entry block 527. For the embodiment shown an example block 528 provides additional assistance to the user. Next 529 and back 530 buttons are provided to advance after entry of the title or return to the welcome screen.

Touching next after entering the title brings up a subtitle screen 531 for optional entry of a subtitle in text entry block 532. As with the title entry screen, an example prompt 533 is provided which also can include information on system requirements or interaction such as the requirement for additional fees to enter a subtitle in the sales provider's system. Next 529 and back 530 buttons are again displayed for exiting the screen. Touching next brings up a condition screen 534 for entry of information on condition of the sale item. For the embodiment shown, a drop down box 535 with predetermined condition definitions is provided as well as a text entry box 536 for detail description. The condition entry screen is exemplary of the data input screens available for the system which are tailored for interface between the service provider system and the PDA. As will be described below, the PDA can initially prompt for a service provider definition prior to commencing the new listing process which will select and sequence the input screens based on the data available or required for listings on that service provider's system.

Upon completion of the text entry elements of the listing, touching next brings up a sales type option screen 583. Consistent with most current sales service provider systems, a fixed price button 537 and an auction button 538 are provided. For the embodiment shown, a check box 539 is associated with each sale type for selection. Touching the auction button launches an auction screen 540 providing text entry blocks for starting bid 541, reserve 542 and retail value 543 with a drop down box 544 with preselected auction periods. Similarly, pressing the fixed price button launches a fixed price sale screen 545 with text entry blocks for “Buy It Now” pricing 546 and retail value 547 and a drop down box 548 with preselected sales periods.

Completing or skipping the sales type screens, a shipment selection screen 549 is launched providing drop down boxes for shipment carrier 550 and pricing 551, which for the embodiment shown allows either fixed rate or calculated. A fixed rate selection allows entry of a shipping rate in text box 552. A packaging type drop down selection 553 is also provided. A selection of “calculated” in the drop box as shown in shipment selection screen 549 brings up a screen 554 for entry of shipping data such as weight and dimensions in text entry boxes 555.

Continuing with FIG. 5F, additional item information screens such as manufacturer screen 556 and model number screen 557 provide text boxes for entry of data. For commonly offered manufacturers, the system will provide preloaded data which is presented in additional screens such as the category selection screen 558 for selection by the user to supplement entered data. A final listing description is displayed in a review screen 559 with scroll bars 560 allowing the user to verify data as entered and as will be presented to the sales system provider for uploading and presentation to their customers. For the embodiment shown, elements of the description that have been entered are shown in highlighted text 561 and touching the highlighted text will return the user to the entry screen for that element to allow revision or correction.

Data for the created listing is now complete in the PDA based system. A listing location screen 562 is then presented to the user identifying the various sales service providers with which the PDA has been registered as previously described. Selection boxes 563 allow one or more listing services to be employed. A sell button 564 is provided for connection with the selected sales service provider. Upon connection and transmission of the listing to the provider, a payment confirmation screen 565 is presented with option buttons. In the exemplary embodiment shown, the confirmation screen provides cost information for the listing. An accept button 566 allows the user to accept the costs and enter the listing on the service. If the listing is error free, a submission success screen 567 is presented. On the exemplary screen, the user can then select a done button 568 to exit the system or a new listing button 569 for selection of an additional listing for entry from titles of saved entries.

If an error is identified in an attempted submission, a listing error identification screen 570 is presented identifying to the user that an error exists and requiring correction through logging on to the sales service provider's system via an internet terminal. This screen then gives the user option buttons for done or a new listing selection.

As an alternative to accepting the entry of the listing on the service, a save button 571 on the payment confirmation screen allows the user to store the listing data with the sales service provider for future access. If this option is selected, a data saved confirmation screen 572 is presented which again provides done or new listing selection buttons.

At the listing location screen 562 a review button 573 is also provided to allow the user additional options prior to entry of the listing with a sales service provider. If a single service provider has been selected, selection of the review button prompts a listing review screen 574 allowing the user to review all elements of the listing. A revise button 575 allows the user to access the various data entry screens through a revise listing screen 576. A submit button 577 is selectable to create an automated review of the listing. If successful, the listing locations screen is presented again. If an error is detected, a listing error screen 570 is presented which identifies the error and allows correction. Upon correction, the listing location screen is again presented to allow a sell button selection. A save button 571 is provided to allow the listing to be saved in the PDA memory.

At the listing location screen 562, if multiple sales service providers are selected as represented in the listing location screen as shown, options for the service providers are presented responsive to a next button selection in listing upgrade screens 580 providing various entry options. For the embodiment shown, warning screens 581 are presented if selection of entry options results in additional cost. Selection of the desired options and selection of a next button and/or acknowledgement of the warning screens by selection the next button results in submission of the listing to the service provider with presentation of the payment confirmation screen.

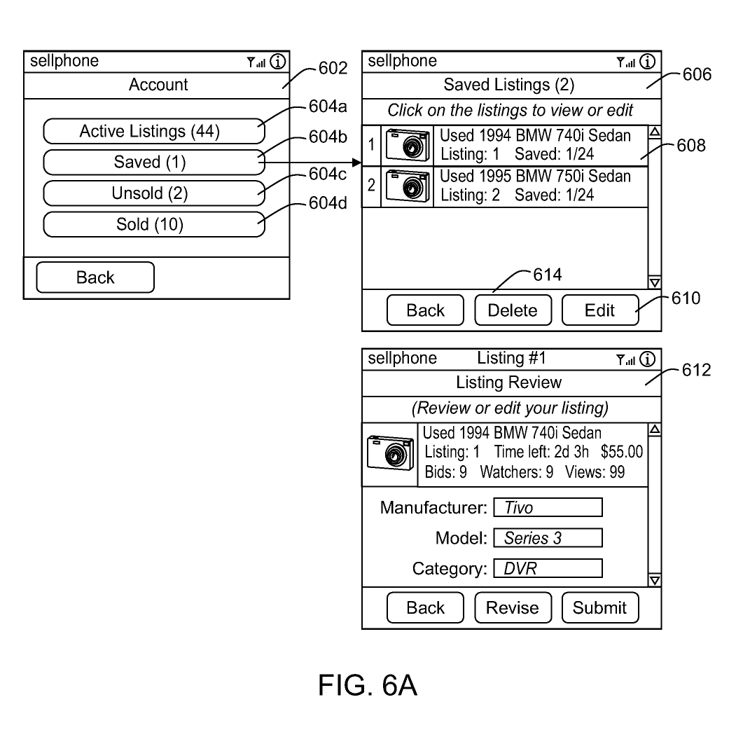

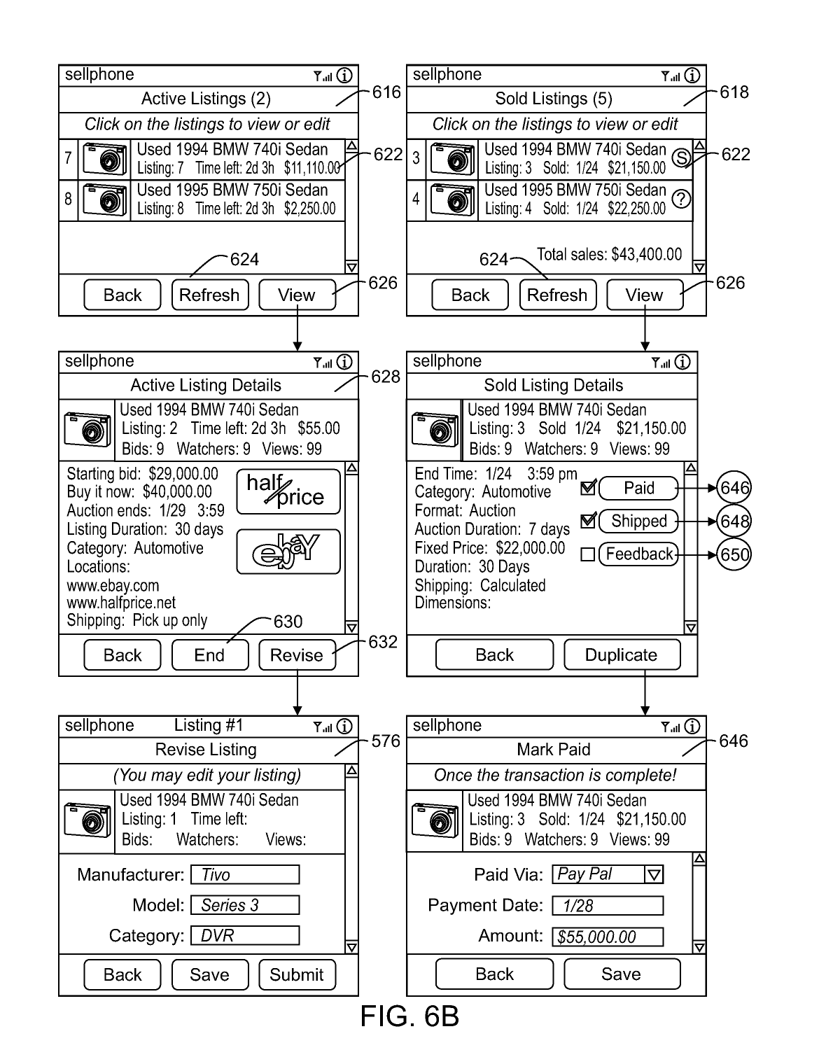

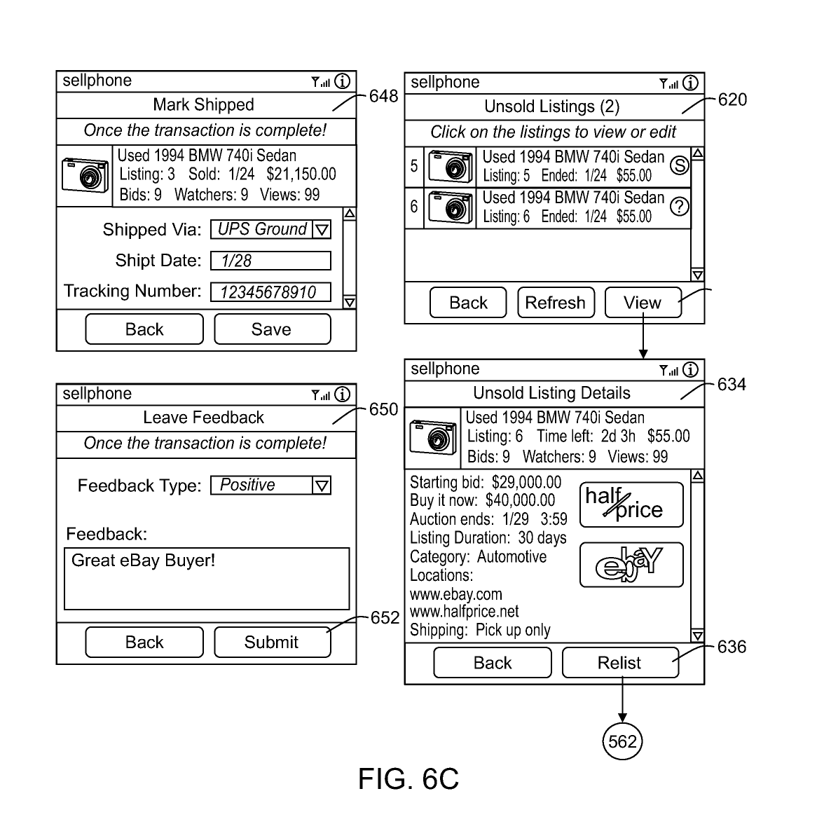

As previously identified with respect to the welcome screen 502 presented to the user upon initializing the system on the PDA, additional capability is provided as shown in FIGS. 6A through 6C for account maintenance upon touching of the my account button 504b. An account screen 602 is presented with option buttons for review of saved listings 604a, active listings 604b, unsold listing 604c, and sold listing 604d.

Selection of the saved listings button launches a saved listing screen 606 which provides identifiers 608 for each listing save in the PDA memory. An “edit.” button 610 is provided for selection by the user to produce a listing review screen 612 of a selected listing with the features previously described to revise or submit the listing. Alternatively, a delete button 614 is provided to allow deletion of a selected entry.

The active listing, unsold, and sold selection buttons for the account screen provide information on listings previously submitted and prompt information and response screens based on interactions typically required with the sales service providers. Touching the respective buttons results in presentation of an active listing screen 616, a sold listings screen 618 or an unsold listings screen 620 respectively. Each of these screens provides identifiers 622 for each listing in that category, a refresh button 624 for connection to the service provider to update the status of the listings and a view button 626 to view the listing for a selected identifier.

For the active listings, responsive to the view button for a selected identifier, a details screen 628 is presented with all elements of the listing and the transaction status with the sales service provider's system. An end button 630 is provided to terminate the listing. A revise button 632 is provided to launch a revise listing screen 576 with functionality as previously described.

For unsold listings, responsive to the view button for a selected identifier, an unsold listing details screen 634 is presented showing the details of the listing and providing a relist button 636 which when touched transitions that listing to the listing locations screen 562 for reprocessing.

Finally, for sold listings, responsive to the view button for a selected identifier, a sold listing details screen 638 is launched which details the listing and provides buttons for designating paid 640, shipped 642 and feedback 644. Each of these buttons launches one of three respective screens; mark paid 646, mark shipped 648, and leave feedback 650 which allow entry of details regarding that function as text and/or drop down boxes. The leave feedback screen, in turn, has a submit button 652 allowing text feed back entered on the screen to be submitted to the buyer through the sales service provider system.

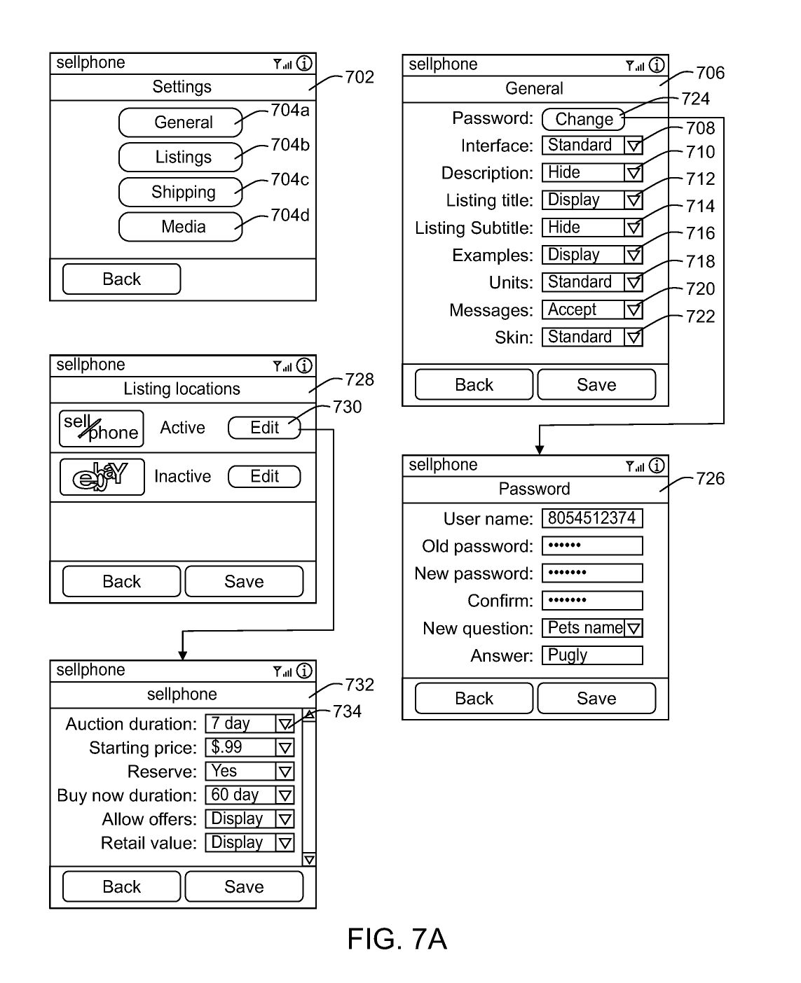

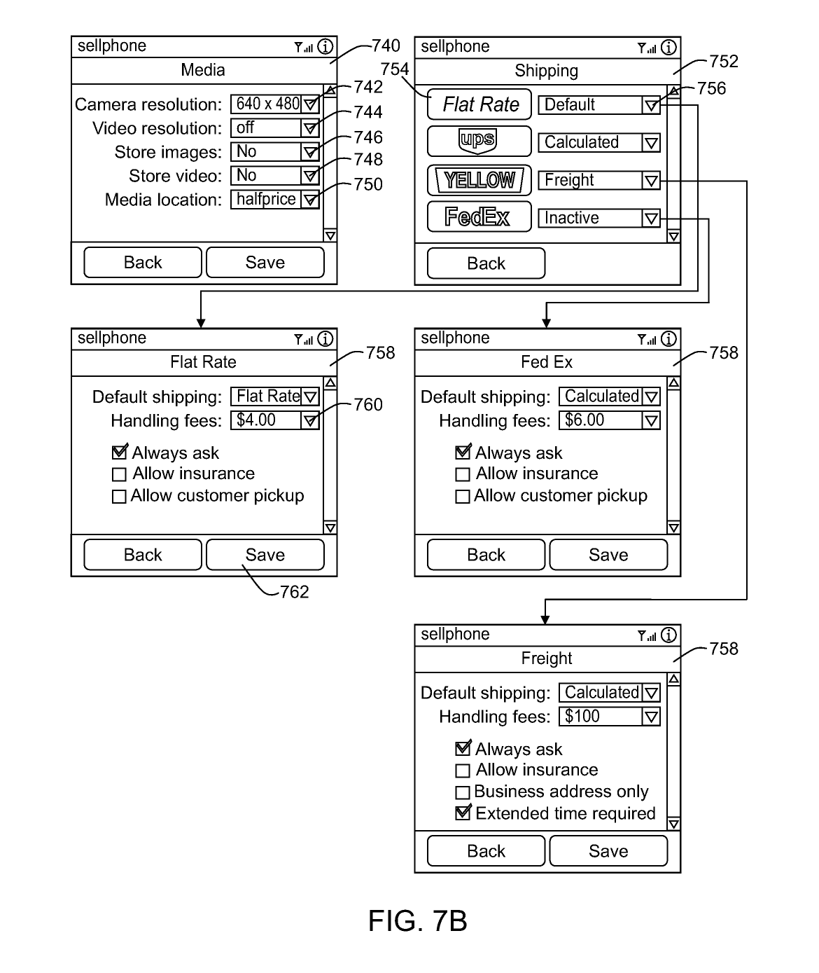

Returning to FIG. 5A, selection of the settings button 504d on the welcome screen launches a settings screen 702, as shown in FIGS. 7A and 7B, which provides for entry and selection of preferences for system elements. A “general” button 704a launches a general preferences screen 706 which identifies and provides for modification of system preferences such as, for the exemplary embodiment shown, interface with the sales service provider's system using a drop down box 708 for preselected interface options. An ability to hide or show the description of listings is provided with a drop down box 710, listing title with drop down box 712, listing subtitle with dropdown box 714 and examples with drop down box 716. A selection of units of measure for the shipping and other system functions is provided in drop down box 718. Enabling or disabling message communication with the PDA by the sales service providers is established using drop down box 720. A “skin” or screen appearance is provided via drop down box 722. A button to change password 724 launches a password screen 726 which allows entry of password information and verification data.

A listings button 704b on the settings screen launches a listing locations screen 728 which identities the sales service providers with which the PDA system is registered. The listing locations screen allows selection of and identities the status of each provider as active or inactive and provides edit buttons 730 for modification of general data inputs specifically associated with each provider. As exemplary, provider screen 732 incorporates drop down boxes 734 for selection of default values for such values as auction duration, auto re-list, starting bid, reserve, make offer, retail value, subtitles, picture options, picture show, Gallery options and Text options. Similarly, alternate provider screens provide similar selection capability for each alternative provider.

A media button 704d on the settings screen launches a media options screen 740 which allows selection of properties for media to be used in association with the listing including camera resolution with a drop down box 742 and video resolution with drop down box 744 to allow the user to maximize storage. An option to store or not store images or video generated during development of listings is provided in drop down boxes 746 and 748. If media is not permanently stored on the PDA, transfer of the listing data generated in the listing process previously described will result in deletion of the associated media files for that listing in the PDA memory. For a sales provider with which media storage is provided with listings, a drop down box 750 for identification of that provider is available.

Finally on the settings screen a shipping button 704c is provided to launch a shipping screen 752. The shipping screen incorporates selectable identifiers 754 for multiple shipping entities with drop down boxes 756 for selection of shipping types assigned. Selection of the identifier for any shipping entity launches an entity screen 758 which provides detail information selectable by dropdown boxes 760 for shipping alternatives to be presented as a portion of prepared listing.

In each of the preferences screens a save button 762 is provided to save changes to the preferences entered on the screen.

Exemplary Computing Device

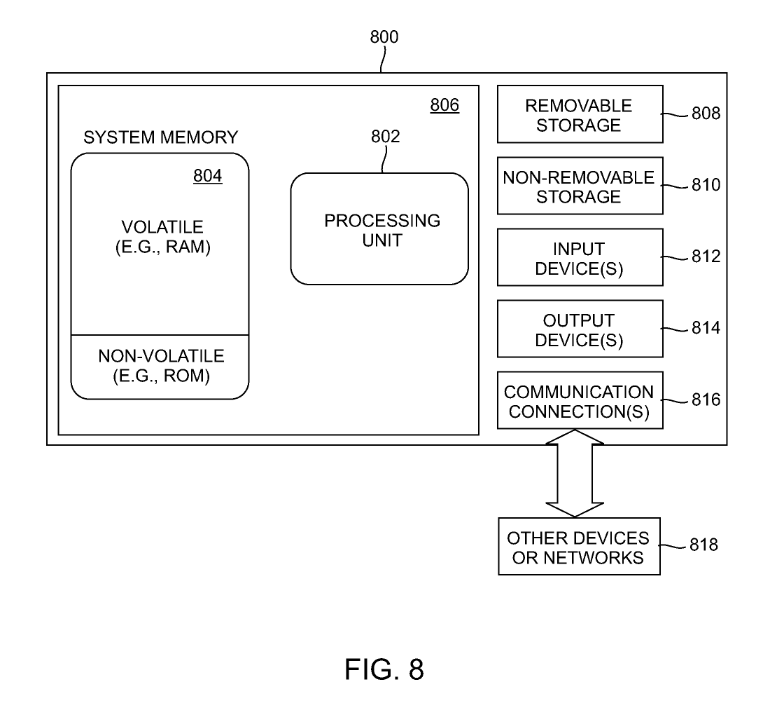

FIG. 8 is a functional block diagram generally illustrating a computing device 800, one or more of which can be adapted for use in the illustrative system presented below. The computing device 800 can be, for example, a personal computer, a handheld device such as a cell phone or a personal digital assistant, multi-processor systems, microprocessor-based or programmable consumer electronics, network PCs, minicomputers, mainframe computers and the like. A distributed computing environment where tasks are performed by remote processing devices 800 can be linked through a communications network. In a distributed computing environment, program modules can be located in both local and remote memory storage devices.

In its most basic configuration, computing device 800 typically includes at least one processing unit 802 and system memory 804. Depending on the exact configuration and type of computing device, system memory 804 can be volatile (such as RAM), non-volatile (such as ROM, flash memory, etc.), or some combination of the two. The basic configuration of the device 800 is illustrated in FIG. 8 within dashed line 806.

Device 800 can also have additional features and functionality. For example, device 800 can also include additional storage (removable and/or non-removable) including, but not limited to, magnetic or optical disks or tape. Such additional storage is illustrated in FIG. 8 by removable storage 808 and non-removable storage 810. Computer storage media includes volatile and nonvolatile, removable and non-removable media implemented in any method or technology for storage of information such as computer readable instructions, data structures, program modules, or other data. Memory 804, removable storage 808, and non-removable storage 810 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by device 800. Any such computer storage media can be part of device 800.

Device 800 can include one or more input devices 812 such as a keyboard, mouse, pen, voice input device, touch input device, scanner, or the like. One or more output devices 814 can also be included, such as a video display, audio speakers, a printer, or the like. Input and output devices are well known in the art and need not be discussed at length here.

Device 800 also contains communications connection 816 that allows the device 800 to communicate with other devices 818, such as over a local or wide area, network. Communications connection 816 is one example of communication media. Communication media includes any information delivery media that serves as a vehicle through which computer readable instructions, data structures, program modules, or other data can be delivered on a modulated data signal, such as a carrier wave or other transport mechanism. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, electromagnetic (e.g., radio frequency), infrared, and other wireless media. The term computer readable media as used herein includes both storage media and communication media.

Illustrative Environment

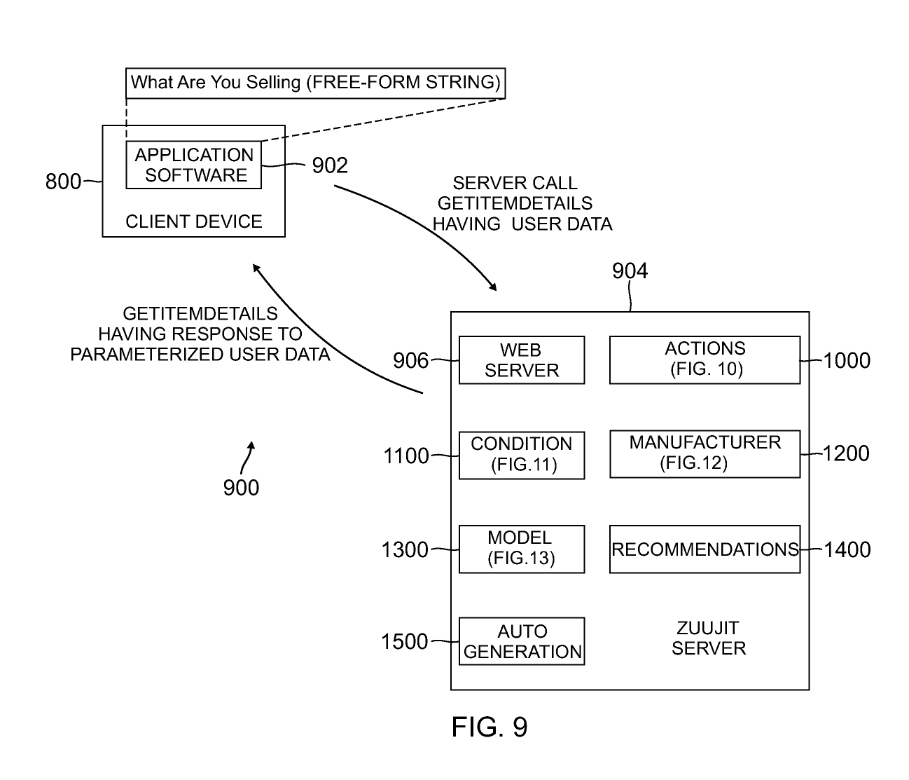

FIG. 9 is a functional block diagram generally illustrating an exemplary environment 900 for the client device 800, having application software 902, to interact with a server 904, and as shown a Zuujit Server, to send a free-form string and receive recommendation data in the form of parameterized information as presented below. While not show, the environment 900 can also include a network, such as the Internet, which transmits communications between the client device 800 and the server 904. Each of the components can be interconnected over the Internet. Although the following discussion will make reference to the Internet as a specific wide area network, those skilled in the relevant art will appreciate that any mechanism for connecting multiple computing devices can equally be used.

The device 800 can be connected to the Internet over a network connection, such as a dial-up modem connection or digital subscriber line connection. The device 800 can be adapted to interact with other computing devices over the Internet through application software 902. The application software 902 can be integrated into a subsystem of an operating system executing on the device 800. Via the application software 902, a user of the device 800 can retrieve data from other computing devices attached to the Internet, and can additionally provide information to those other computing devices.

Typically, device 800 and server 904 are used in conjunction with an online marketplace or advertising website (not shown). In particular, and in one embodiment, an eBay auction agent, StubHub marketplace agent, and craigslist advertising agent can be used to receive item information from the client device 800. Those familiar with online marketplaces or advertising websites will recognize that there are many such agents that can be connected to client device 800 through the Internet. Furthermore, many configurations of the exemplary environment 900 provided herein can be used to illustrate the communications, or lack thereof, between the pieces.

System Operations

Continuing with FIG. 9, exemplary system operations are now described. As shown, and as will be illustrated in more details below, application software 902 on client device 800 receives keywords from a user. Those keywords are then placed into a free-form string. Typically, the free-form string includes keywords that describe an item that the user is intending to sell. A “What Are You Selling (WAYS)” screen can be provided by the application software 902 to prompt the user for the input.

In one example of the free-form string, the user can enter the keywords “TiVO Series2”, “Antique wooden duck”, “The Matrix DVD”, or “Signed Mickey Mantle baseball card.” These keywords can represent items that the user is intending to sell. For future reference, these keywords will be referred to again for exemplary purposes.

After the free-form string is received, the application software 902, establishes a connection with the server 904. The application software 902 running atop of client device 800 generates a server call to the server 904 having the user data in the form of the inputted string. The server call, as shown in the present illustration, is called GetItemDetails.

The server 904 receives the GetItemDetails server call through a web server 906. Generally described, the web server 906 administers data flow and interfaces with the device 800 via the Internet. The server 904 then parameterizes the string within the call.

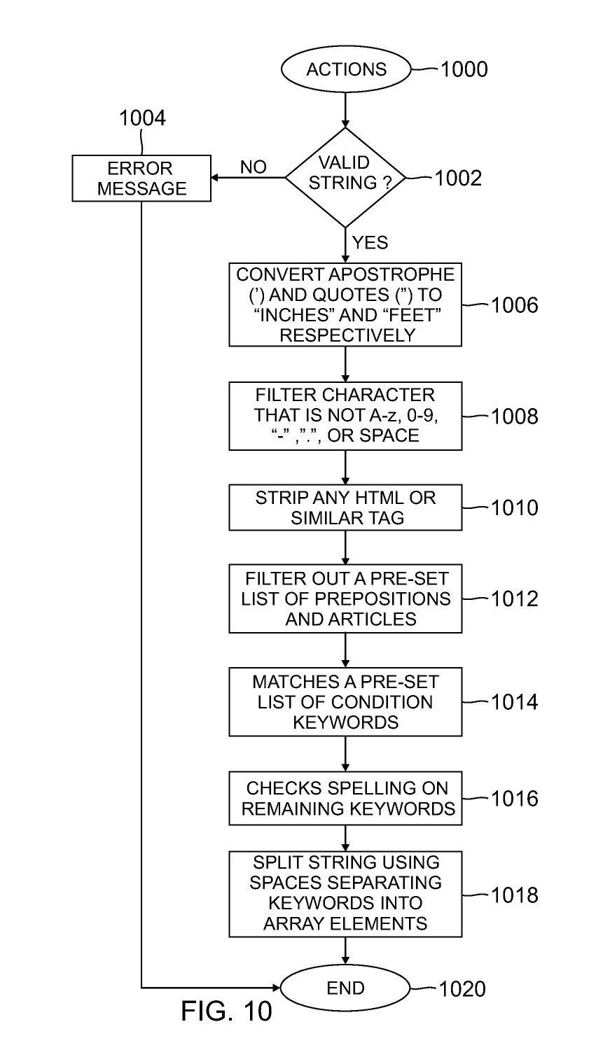

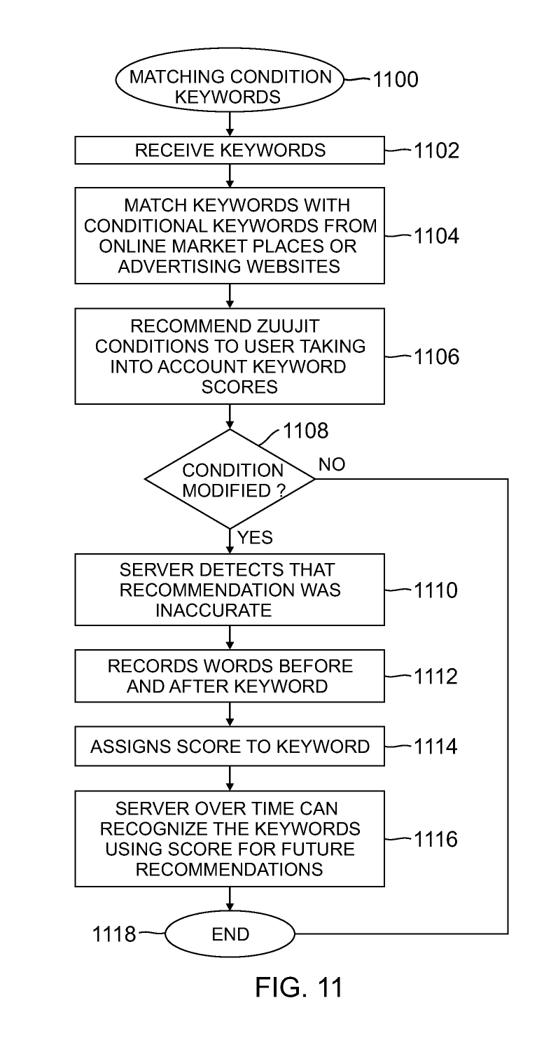

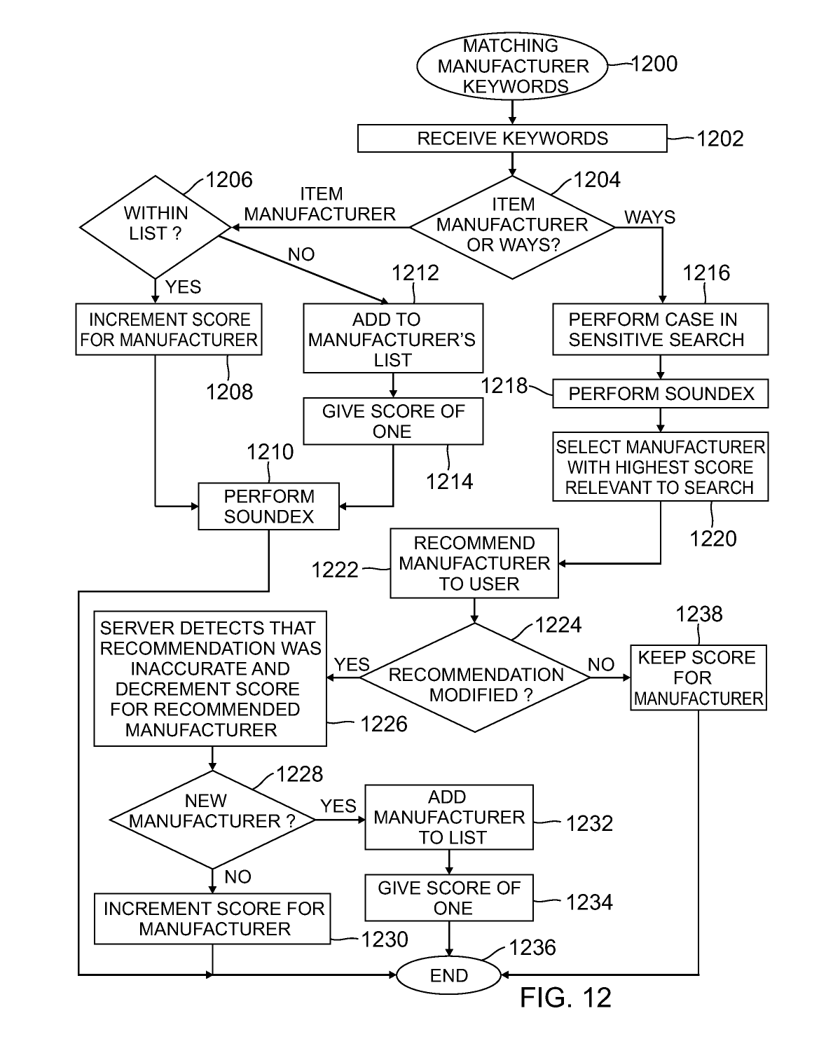

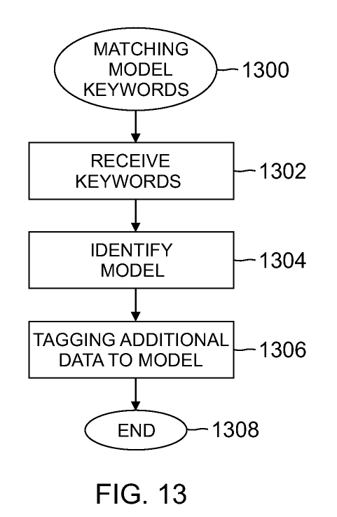

The parameterization of the string by the server 904 can include, but is not limited to, performing actions 1000 on the string to generate a set of keywords (as will be shown in FIG. 10), matching conditions 1100 with those keywords (as will be shown in FIG. 11), matching manufacturers 1200 with the keywords (as will be shown in FIG. 12), and matching models 1300 with the keywords (as will be shown in FIG. 13).

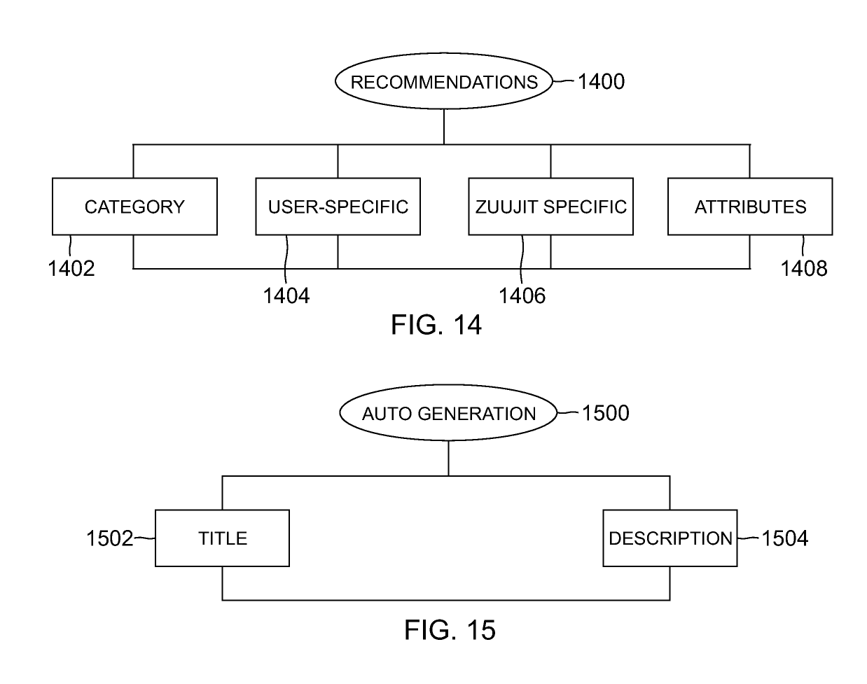

Furthermore, the server 904 can make recommendations 1400 about an item based on the previously made matches (as will be shown in FIG. 14). The parameterization can also include recommendations 908. These recommendations 908 can include category recommendations, user-specific recommendations, server-specific recommendation, and attribute recommendations. In addition, server 904 can automatically generate 1500 information including a title and description of the item (as will be shown in FIG. 15).

After parameterization of the incoming string from the GetItemDetails server call, as described above, server 904 responds by sending the parameterized data back to the client device 800 as shown in FIG. 9, which includes the recommendations and automatically generated information.

Actions Performed

Previously, and as shown in FIG. 9, client device 800 sends the WAYS free-form string to the server 904 and a series of actions are performed on the string. These actions are described in more detail in FIG. 10. Preferably, the client device 800 sends the string via an XML server call, i.e., GetItemDetails.

FIG. 10 provides an illustrative flow chart for parsing a string received from a client device 800 to generate an array of keywords in accordance with one aspect of the present application. The process begins at block 1000. At determination block 1002, server 904 verifies whether the incoming string is valid. If not, an error message is returned back to the client device 800 at block 1004 and the process ends at block 1020. If a valid string is detected, server 904 converts apostrophes (') and quotes (“) to inches and feet respectively at block 1006. Generally, the conversation takes place if the apostrophes (') and quotes (“) are found to the right of any digit. In other embodiments, the apostrophes (') and quotes (“) can indicate other known measurements.

At block 1008, preferably server 904 filters characters that are not “A-z”, “0-9, “-”, “.” or a space out of the string. Alternatively, all characters can be included making block 1008 optional.

Often the string received from the client device 800 contains XML. At block 1010, server 904 strips any HTML or similar tags from the string. This prevents the tags from being read and evaluated by the server 904 and further prevents the server 904 from recommending data based on false evaluations of the tags.

At block 1012, the server 904 removes a pre-set list of prepositions and articles. For example, and continuing with the example provided above, the word “The” would be removed from “The Matrix DVD”. One skilled in the relevant art will appreciate that some prepositions and articles can include, but are not limited to, “a”, “and”, and “the”.

At block 1014, a pre-set list of conditions can be matched with keywords within the string. For example, if a user types in “NIB” into the client device 800, the server 904 would recognize the words as standing for “Not In Box” according to the pre-set list. As another example, “Refurb” would be recognized as “Refurbished”. The pre-set list of condition keywords can be from a plurality of online marketplaces and advertising websites. For example, eBay can has its own set of pre-set list of condition keywords, while craigslist can also have its own list. Typically, the matched keywords are then updated with the equivalent condition in the pre-set list.

At block 1016, server 904 can check the spelling on the keywords. If any words are misspelled, server 904 can update those words with the correct spelling. In most embodiments, spelling errors are liberally construed. By allowing a liberal construction, the server 904 would not correct company names, odd sounding devices, etc.

At block 1018, server 904 can split the string into keywords. In one embodiment, this can be done by separating those terms that are delineated by a space. Generally, the keywords can be placed into an array of keywords. The process ends at block 1020. The blocks presented above are in no particular order and should not be construed as limiting to the scope of the present application.

Matching Conditions with Keywords

Often, within the array of keywords are conditions. Conditions can represent the state of an item such as “new” or “used”. FIG. 11 is an exemplary flow chart for matching keywords provided by the client device 800 with item conditions in accordance with one aspect of the present application. Generally described, keywords are matched with conditions from online marketplaces and/or advertising websites. The matches are then associated with server conditions, which are provided back to the user.

The process begins at block 1100. At block 1102, keywords are received. The keywords are then matched with conditional keywords from online marketplaces or advertising websites at block 1104. Typically, only conditional keywords are isolated when matched. For example, “nibble,” which has the letters “nib” in it, should not be matched. At block 1106, the server 904 recommends conditions based on those matches made in block 1104.

As an example, eBay, a well known online auction website, has conditions NIB” or “New In Box”. These conditions, when found in the received keywords, can be matched to server 904 conditions. The eBay matched conditions would be associated with the server 904 condition “New”. As another example, “VGC” or “Very Good Condition”, which are eBay conditions, can be linked with server 904 condition “Used-Very Good”. Other server 904 conditions can include “new”, “like new”, “used-very good”, “used-good”, “used-acceptable”, and “refurbished”. These server 904 conditions would then be provided to the client device 800, instead of the conditions related to the online marketplaces or advertising websites.

Continuing with block 1106, the server 904 recommends the matching server 904 conditions to the user taking into account keywords scores. Keyword scores will be described in more detail below. In essence, the scores represent the likelihood that the online marketplace and/or advertising conditions were matched with a server 904 condition. The server 904 provides the recommendation back to the client device 800 in the GetItemDetails response.

At determination block 1108, server 904 determines whether those server 904 conditions that were recommended were modified by the user through the client device 800. When the condition was modified, the server 904, at block 1110, detects whether the recommendation was inaccurate.

Because the condition has been modified, it was an inaccurate recommendation by the server 904. To remove these types of recommendations, the server 904 records the words or terms before and after the keyword that the server 904 condition was recommended at block 1112. A score is assessed to the keyword at block 1114. Through the score, and over time, the server 904 can recognize the keywords that are not condition keywords using the score for future recommendations at block 1116. The process at block 1118.

Returning to determination block 1108, if the server 904 does not detect a modification to the recommended condition, then the process ends at block 1118.

As an example of the concepts provided above, there are cases when the word “new” might appear and not be a condition, for example, “New York Yankees”. Because the word “New” would be recognized as a condition, the processes provided within the flow chart above would be able to discern it from a condition. In these cases, it is possible to keep track of words surrounding “new” and keep track of which recommendations are submitted in the final listing.

In another example, the user types in “New York Yankees Jersey Used.” The matching condition keywords processes described in the flow chart above would find “new” and “used” in the string. Without knowing anything else, the server 904 would recommend the term “new”, which was the first word. The server 904 condition “New” which has been recommended to the user is pre-selected on the condition page. The user through their client device 800 then modifies that recommendation to be “Used-Very Good” and submits the listing with that modification. The server 904 can then detect that its recommendation was inaccurate. By recording the words immediately before and after the word “New” and assigning a score, the server 904 becomes more intelligent in its recommendation. For example, “York” is the only word touching “New.” Over time, the server 904 can recognize that “New” followed by “York” does not mean a “New” condition. Generally, once the score reaches a pre-set level (i.e. enough people have used “New York” in their WAYS and modified the recommendation), the server 904 can recognize that keyword combination and stop recommending the server 904 condition “New” for that keyword combination.

Matching Manufacturers with Keywords

FIG. 12 diagrams a flow chart for matching keywords provided by the client with manufacturers in accordance with one aspect of the present application. As a basic example, if one of the array elements contains the keyword “sony,” then that might match an existing entry of “Sony” and the server 904 would recommend that manufacturer to the user.

Before describing the processes for matching manufacturers with keywords, it should be pointed out that the server 904 can maintain a manufacturer's list. The manufacturer's list is a list of distributors, producers, makers, companies, firms, etc. that have products and services with each having an associated score. Typically, the list is ranked by the scores, associated with the manufacturers. Based on those scores, server 904 can recommend a manufacture. Normally, the higher the score, the more likely the server 904 will recommend the manufacturer.

At block 1200, the process for matching manufacturers with keywords begins. At block 1202, keywords are received. In this illustrative process, there are two fields in the client application that help to populate the manufacture's list: itemManufacturer and WAYS. Accordingly, at determination block 1204, server 904 decides whether keywords were placed in an itemManufacturer field or WAYS, which was described above.

When keywords have been placed into the itemManufacturer field, server 904 determines whether the keywords received are within the manufacturer's list at determination block 1206. Generally described, the itemManufacturer field allows a user to add a manufacturer directly to the manufacturer's list. For example, if the user types in “TiVo” in this field, then the server 904 knows that “TiVo” is a manufacturer and can automatically add that entry to the manufacturer's list.

If the keyword is within the manufacturer's list, the score for the manufacturer associated with the keyword is incremented at block 1208. At block 1210, a Soundex, or equivalent, score is recorded for further matching. The Soundex score is essentially a calculation based on English pronunciation. For example, “TiVo” is programmatically equivalent to “TeeVoh”. After block 1210, the process ends at block 1236.

When the keyword is not within the list, at block 1212, the server 904 adds a new manufacturer to the list. At block 1214, the server 904 gives a score of one to the manufacturer in the manufacturer's list. The score of one indicates that the manufacturer has been newly entered in. As will be shown below, the higher the score, the more likely that the manufacturer will be recommended. At block 1210, as described above, a Soundex, or equivalent, score is recorded for further matching. After block 1210, the process ends at block 1236.

Returning to determination block 1204, when keywords have been entered into WAYS, the server 904 performs a case insensitive search within the manufacturer's list using those keywords at block 1216. In addition, server 904, at block 1218, performs a Soundex score to match the keywords entered in WAYS. At block 1220, server 904 selects the manufacturer with the highest score relevant to the search in the manufacturer's list and recommends the manufacturer to the user at block 1222.

As an example, when the user types in “TiVo” in WAYS, the server 904 can look for a match in the manufacturer list, and be able to recommend it to the user if the score is above a pre-set limit. If the user types in any variation of “TiVo”, for instance misspelling, different capitalization, etc., the server 904 can perform both a case-insensitive search and a Soundex search to recommend the match with the highest score. Generally, the system assumes that most users can spell correctly and with proper capitalization. Alternatively, if a user types in “teevoh,” then by matching Soundex values, “TiVo” would most likely be the highest score recommendation to pre populate the itemManufacturer field.

At determination block 1224, server 904 can decide whether the recommendation has been modified by a user. When the server 904 recommendation has been modified, at block 1226, server 904 detects that the previous recommendation was inaccurate and decrements the score for the previously recommended manufacturer. At determination block 1228, server 904 decides whether the new recommendation by the client device 800 is a new manufacturer. At block 1230, when the manufacturer is not new to the list, then the score is incremented for the manufacturer and the process ends at block 1236. When a new manufacturer has been provided by the user, the manufacturer is added to the list at block 1232. At block 1234, the manufacturer added to the list is given a score of one and the process ends at block 1236.

Returning to determination block 1224, the score for the recommended manufacturer is kept when the recommendation that was previously sent to the user has not been modified at block 238. The process ends at block 1236.

In some instances, hyphenated manufacturers (e.g. Williams-Sonoma) or multiple word manufacturers (e.g. Pottery Barn) can require some additional checking with combinations of keywords. For example, if the user enters “Pottery Barn Leather Ottoman” in WAYS, the keywords of the resultant array are “pottery,” “barn,” “leather,” and “ottoman”. By performing a check on of each of these individual keywords some or no matches can be made, but a combination of “pottery” and “barn” would likely result in a higher ranked match. “barn”, “leather”, and “ottoman” likely will not have scores higher than “pottery” and “barn”.

Generally, server 904 combines only words next to each other. For example, it is unlikely a user entering “pottery leather barn ottoman,” would be looking for the manufacturer “Pottery Barn”. By removing the search for words that are not connected to each other, processing time is saved. Essentially, the server 904 is interested in keyword permutations, and not combinations. This same logic is applied for three or four word manufacturers.

Matching Models with Keywords

FIG. 13 shows a flow chart for matching keywords provided by the client with models in accordance with one aspect of the present application. The matching of models follows closely with the matching of manufacturers, with the primary difference being that the list of models is dependent on the manufacturer. For example, if there is an “MP640” made by both Canon and Toshiba, then the recommended one can be that which matches the manufacturer entered. In this way, the model can be used as an additional check for recommended manufacturer. Models can take many forms (e.g. KX-1234, Nano, Vista Ultimate, etc.) so it is harder to match variations in spelling or capitalization. Nevertheless, some of the mechanisms used in the manufacturer matching can be used in model matching.

Other than recommending the model to the user, the primary benefit for detecting the model is that additional data can be tagged onto it. For example, the Canon MP640 can have specific dimensions and weight (for shipping), retail value, category, selling recommendations, etc., which allows for the ability to pre-populate most values of a listing just by entering the model into WAYS.

Continuing with FIG. 13, the process for matching model keywords begins at block 1300. At block 1302, keywords are received. Using those keywords, model information can be identified at block 1304 by the server 904. Additional data is tagged to the model at block 1306 and the process ends at block 1308.

Recommendations

FIG. 14 is a block diagram that provides illustrative recommendations based on the received keywords and matches made in accordance with one aspect of the present application. As shown, categories 1402 can be recommended to the client device 800. Typically, these categories are received from an online marketplace or advertising website. In one example, eBay can provide the categories. Typically, users are required to choose, from a list of 10,000+ categories, the one that is most representative of the item they are selling. eBay provides an API to obtain a list of the top ten categories given a search query. This API returns a maximum of ten categories, ranked by the most closely matched. This list is then parsed and translated as a response to the client, whereby the user sees a recommendation of categories based on their WAYS. In the event that the user is using research provided by DataUnison (set as a flag in the XML request to GetItemDetails), a smaller category list (in most cases, only one category) can be returned. The user can have a chance to select or modify the recommended category on the client device 800.

Users can provide their own specific recommendations, i.e., user specific recommendations 1404. As a way to enhance the recommendations for a given user, the user's history to increase the accuracy of recommendations can be used. If a user predominantly sells the same class of item (e.g. books, Star Wars memorabilia, baby clothes), then the server 904 can weight recommendations in those categories higher than others. For example, if a user were selling a pair of baby pants with a tractor on it, and the user has a history of selling baby clothes, then the server 904 should not recommend industrial equipment to the user. The same principles can be applied to other aspects of the listing process, taking into account selling success rate or other trends so that the user has less to specify per listing.

Server specific recommendations 1406 can be provided. Once there is enough data residing on the servers about past sales for all users, recommendations can be weighted according to best selling practices. For example, if one hundred users sell the same type of item regularly, the server 904 can analyze historical sales data for those users and determined that a certain configuration of listing settings achieves a higher success rate. This allows sellers to benefit from the success of others by creating a more attractive listing to the buying market.

Attribute recommendations 1408 can be provided. Continuing with the eBay example provided above, for certain eBay categories, attributes are provided for sellers to provide specification level details by which buyers can search. For example, the laptop category might have the attributes for processor speed, memory, hard disk space, screen size, etc. Prospective buyers can then search by these fields to find laptops that fit certain criteria. Using recommended values of condition, manufacturer, and model, some of these attributes can be pre-assigned. For other attributes (ones that provide a list of options to choose from), string matching can help determine values. For example, if the Screen Size attribute from eBay has the options “11 inches & Under”, “12 inches”, “13 inches”, and on up to “17 inches & Up”, it would be possible to isolate a string such as “14″” or “14 inch” from the WAYS and match that against the equivalent attribute option. This type of mechanism would use pre-processing of attribute options to extrapolate ranges and units, which could be done every time an updated attribute option list is obtained from eBay. Over time, a string such as “1 DELL LAPTOP D600 1.6 GHz 512 MB 40 GB NR 2 DVD 14” WiFi” might be able to be broken down into manufacturer=Dell, model=D600, processor speed=1.6 GHz, memory=512 MB, primary drive=DVD ROM, screen size=14 inches, all from user contributed data.

Auto Generation

Based on the recommendations 1400 described above, it would be possible to automatically generate a title 1502 and a description 1504 for the received keywords as depicted in FIG. 15. One skilled in the relevant art will appreciate that these auto generations 1500 are exemplary and should not be construed as limiting to the scope of the present application.

As shown, a meaningful listing title 1502 can be recommended to the user. The title 1502 is essentially a concatenation of keywords, but it could look something like “<<condition>> <<manufacturer>> <<model>> <<unused WAYS elements>> <<attribute>> <<reserve presence>> <<user supplied condition>>”. As an example, it a user enters “samsung sincmaster 940b 19 monitor nib” in WAYS, and assuming all recommendation engines were in place and populated, server 904 would produce the following values:

Manufacturer = “Samsung”
Model = “SyncMaster 940B”
Zuujit condition = “New”
User-entered condition = “nib”
Unused WAYS elements = “monitor”
Screen Size = “19 inches”
Category = “Computers & Networking > Monitors & Projectors >
LCD, Flat Panel > 19 Inches”

If the user chose an auction with no reserve price, the following title 1502 could be automatically generated: “New Samsung SyncMaster 940B Monitor 19”—NR NIB”. The category levels could also be parsed for most descriptive words such as “Monitor,” LCD,” and “Flat Panel.” There would be many cases where there is no manufacturer or model or condition, and the title 1502 would have to be a stylized version of the user's WAYS. For example, if the user enters “antique wooden duck,” the server has very little information to work with. With the given template, the generated title 1502 (using title 1502 casing rules) would be: “Antique Wooden Duck.” Since eBay has a limit of fifty-five characters for their listing title 1502, keywords would be prioritized in importance (manufacturer would be higher priority than screen size, for example) such that less priority keywords would “fall off” the title 1502.

Continuing with FIG. 15, using all of the data assembled from the listing, including manufacturer, model, condition, listing options (starting bid, fixed price, etc.), shipping information, scheduling, category, etc., a description 1504 can be generated by the server 904 and sent to the client device 800. The description is an “ad libbed” concatenation of preset phrases and user specified keywords that describe the item at a somewhat general level. Different description templates would exist for various categories: a description for a computer part would be different than that of a rare coin, for example.

Parameterization of Returned Data

As shown in FIG. 9, in an effort to minimize the number of calls to and from the client device 800, as much recommendation data 1400 and automatically generated data 1500 as possible should be returned to the client device 800 by the server 904 after the initial call. Because there are options that require the client to prompt the user (e.g. choosing a category), it is necessary to parameterize the auto generated title and auto generated description. Also, since attributes might not have data, those lines in the description and any keywords for the title are not known at the time of the XML response from GetItemDetails. For example, if, for a given WAYS, there were three category options returned, and each category had three different attribute options, the server 904 would respond with an auto generated title and description for each category.

The title and description would have placeholders for the data that will be selected by the user on the attributes screen. This would look something like this:

Input (WAYS): “jbl speakers”
Output:
Category 1: “Home Audio > Speakers & Subwoofers”
a. Attributes: Type, Wireless, Brand, Color
b. Title: “JBL [symbol] model [symbol] Speakers [symbol] attributeType [symbol] [symbol]
attributeWireless [symbol] [symbol] attributeColor [symbol] ”
Category 2: “Car Electronics > Car Speakers & Speaker
Systems”
a. Attributes: Type, Component Type, Size, Brand,
Model, RMS Wattage
b. Title: “JBL [symbol] model [symbol] Speakers [symbol] attributeType [symbol] [symbol]
attributeComponentType [symbol] [symbol] attributeSize [symbol] [symbol] attributeRMSWattage [symbol] ”
Category 3: “Desktop & Laptop Accessories > Speakers”
a. Attributes: none
b. Title: “JBL Speakers”

In each of these cases, any variable surrounded by “<< >>” would be replaced on the client side with the user's selections on the attribute page. The description would follow a similar pattern.

Aspects of the Present Application

In accordance with one aspect of the present application, a system is presented. The system includes a client device for receiving input from a user. The client device generates a free-form string from the input. The input has keywords describing properties of an item to be posted to an online marketplace or advertising website. In addition, the system includes a server for receiving the free-form string of keywords. The server processes the free-form string and returns a parameterization of the keywords within the free-form string. The parameterization of the keywords provide information on how to list the item on the online marketplace or advertising website.

In accordance with another aspect of the present application, a server for providing a client with a plurality of recommendations about art item is presented. The server includes at least one processor. In addition, the server includes a database for storing condition keywords, list of manufacturers, and model keywords. Furthermore, the server includes a memory operatively coupled to the processor. The memory stores program instructions, that when executed by the processor, causes the processor to perform a series of routines.

These routines can include receiving keywords from a user and performing a series of actions designed to parse the keywords into an array. Furthermore, the routines include matching conditions to the keywords within the array to the condition keywords stored in the database. In addition, the routines include matching manufacturers to the keywords within the array to the manufacturers in the list of manufacturers stored in the database. The routines include matching models to the keywords within the array to the models in the model keywords stored in the database and providing recommendations to the user based on the matched conditions, manufacturers, and models.

In accordance with still yet another aspect of the present application, a computer-implemented method for identifying an item is presented. The method includes receiving keywords about the item, the keywords in the form of a string. Furthermore, the method includes sending a request along with the string to a server, the server processing the string and generating a parameterization of the keywords within the string, the parameterization including recommendations based on matched conditions, manufacturers, and models. In addition, the method includes receiving the recommendations from the server and determining if any changes are made to the recommendations and if changes have been made, sending those changes to the server.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A system comprising:
a client device for receiving input from a user, wherein the client device generates a free-form string from the input, the input having keywords describing properties of an item to be posted to an online marketplace or advertising website; and
a server for receiving the free-form string of keywords, wherein the server processes the free-form string and returns a parameterization of the keywords within the free-form string, the parameterization of the keywords providing information on how to list the item on the online marketplace or advertising website.

2. A server for providing a client with a plurality of recommendations about an item, the sever comprising:
at least one processor;
a database for storing condition keywords, list of manufacturers, and model keywords;
a memory operatively coupled to the processor, the memory storing program instructions that when executed by the processor, cause the processor to:
receive keywords from a user;
perform a series of actions designed to parse the keywords into an array;
match conditions to the keywords within the array to the condition keywords stored in the database;
match manufacturers to the keywords within the array to the manufacturers in the list of manufacturers stored in the database;
match models to the keywords within the array to the models in the model keywords stored in the database; and
provide recommendations to the user based on the matched conditions, manufacturers, and models.

3. A computer-implemented method for identifying an item, the method comprising:
receiving keywords about the item, the keywords in the form of a string;
sending a request along with the string to a server, the server processing the string and generating a parameterization of the keywords within the string, the parameterization including recommendations based on matched conditions, manufacturers, and models;
receiving the recommendations from the server; and
determining if any changes are made to the recommendations and if changes to have been made, sending those changes to the recommendations to the server.
